(19) United States
(12) Patent Application Publication
(10) Pub. No.: US 2003/0229470 A1
(43) Pub. Date: Dec. 11, 2003

(54) System and method for analyzing patent-related information

(76) Inventor: Nenad Pejic, Broadview Heights, OH (US)

Correspondence Address: Nenad Pejic, 8467 Camden Court, Broadview Heights, OH, 44147, US

(21) Appl. No.: 10/458,446

(22) Filed: Jun. 10, 2003

Related U.S. Application Data
(60) Provisional application No. 60/387,345, filed on Jun. 10, 2002.

(51) Int. Cl. G06F 17/18

(52) U.S. Cl. 702/179

(57) ABSTRACT

A system and method for analyzing patent-related documents is provided. The method includes, for example, reading patent-related data, identifying at least a first trend associated with the read patent-related data, generating at least one warning based on the identified at least first trend, and generating at least one suggestion based on the identified at least first trend.

### CROSS-REFERENCES

This application claims the benefit of U.S. Provisional Application Serial No. 60/387,345 filed Jun. 10, 2002, which is hereby fully incorporated by reference.

### COPYRIGHT NOTICE

A portion of the disclosure of this patent document contains material which is subject to copyright protection. The copyright owner has no objection to the facsimile reproduction by any one of the patent disclosure, as it appears in the Patent and Trademark Office patent files or records, but otherwise reserves all copyright rights whatsoever.

### FIELD OF THE INVENTION

The invention relates generally to data processing, and more particularly, to systems and methods for analyzing patent-related information to generate observations, warnings, and/or suggestions.

### BACKGROUND

Patent-related documents and information represent a merger between technological and legal concepts. As such, corporate vice-presidents, officers, managers, engineers and marketing personnel often times need to make strategic business decisions in view of technology issues that include patent-related information. These decisions can be especially difficult to make when the underling technology is tied to large numbers of patent-related documents, which may be owned by one or more competitors. In these and other similar situations, there is a need for a patent-centric system and method for assisting corporate officers, managers, engineers, and the like, in making technology-related strategic business decisions.

### SUMMARY

According to one embodiment, a method of analyzing patent-related documents is provided. The method includes, for example, reading patent-related data, identifying at least a first trend associated with the read patent-related data, generating at least one warning based on the identified at least first trend, and generating at least one suggestion based on the identified at least first trend.

### BRIEF DESCRIPTION OF DRAWINGS

FIG. 1 is a block diagram of one embodiment of the system and method for analyzing patent-related data.

FIG. 2 is a block diagram of one embodiment of a technology classifier.

FIG. 3 is a more detailed block diagram of one embodiment of a technology classifier.

FIG. 4 is a diagram of one embodiment of a patent map.

FIG. 5 is one embodiment of a flow diagram analyzing patent-related data.

FIGS. 6A, 6B and 6C are embodiments of flow diagrams identifying and analyzing trends from patent-related data.

FIGS. 7A and 7B are embodiments of flow diagrams generating information based on trends associated with the patent-related data.

FIGS. 8A and 8B are embodiments of flow diagrams generating information based on core technology trends associated with the patent-related data.

FIG. 9 is one embodiment of an output generated by a core technology analytic engine.

FIG. 10 is another embodiment of an output generated by a core technology analytic engine.

FIG. 11 is one embodiment of an output generated by a technology trend analytic engine.

FIG. 12 is another embodiment of an output generated by a technology trend analytic engine.

FIG. 13 is one embodiment of an output generated by a marketing analytic engine.

FIG. 14 is one embodiment of an output generated by a research and development analytic engine.

### DETAILED DESCRIPTION OF ILLUSTRATED EMBODIMENTS

Prior to discussing the various embodiments, a review of the definitions of some exemplary terms used throughout the disclosure is appropriate. Both singular and plural forms of all terms fall within each meaning:

“Logic,” as used herein, includes but is not limited to hardware, firmware, software and/or combinations of each to perform a function(s) or an action(s), and/or to cause a function or action from another component. For example, based on a desired application or needs, logic may include a software controlled microprocessor, discrete logic such as an application specific integrated circuit (ASIC), or other programmed logic device. Logic may also be fully embodied as software.

“Software,” as used herein, includes but is not limited to one or more computer readable and/or executable instructions that cause a computer or other electronic device to perform functions, actions, and/or behave in a desire manner. The instructions may be embodied in various forms such as routines, algorithms, modules or programs including separate applications or code from dynamically linked libraries. Software may also be implemented in various forms such as a stand-alone program, a function call, a servlet, an applet, instructions stored in a memory, part of an operating system or other type of executable instructions. It will be appreciated by one of ordinary skill in the art that the form of software is dependent on, for example, requirements of a desired application, the environment it runs on, and/or the desires of a designer/programmer or the like.

“Patent-related data” as used herein, includes but is not limited to any and all data associated with patent-related documents such as, for example, issued patents and published, unpublished, and pending patent applications, technical documents, and trade secret documents including, for example, technical know-how. The patent-related data can also include any and all data for identifying one or more patent-related documents including, for example, data identifying one or more patent-related documents based on technology or sub-technology type, bibliographic information including information about inventors, assignees, applicants, filing dates, publication dates, issue dates, priority dates, patent office classifications, custom generated classifications, abstracts, serial numbers, publication numbers, issue numbers, etc. The patent-related data can also include trend data.

“Trend” as used herein, includes but is not limited to any prevailing tendency or inclination such as, for example, any general movement in the course of time of a statistically detectable change. A trend can also include any line of direction, movement, development, or approach. Trends can also include any statistical data showing a tendency of some function to grow, decline or remain unchanged over a period of time. As such, a trend can be characterized as, for example, increasing, decreasing, steady or to include combinations thereof.

“Observation” as used herein, includes but is not limited to any output that has a judgment on or inference from what is observed, detected and/or measured. Observations can also include statements of facts or opinions and remarks expressing opinion or judgment.

“Warning” as used herein, includes but is not limited to any output that warns, alerts, or calls to attention one or more observations, facts, or conditions and can include, notices, bulletins, remarks, statements, opinions, and/or messages.

“Suggestion” as used herein, includes but is not limited to any output that calls to attention, urges, proposes or offers for consideration an idea or notion. Suggestions can include, for example suggested business actions or courses of business action that call to attention, urge, propose or offer for consideration a step or series of steps to be considered, evaluated, or performed. The step or steps can relate to business practices, plans, investments, forecasts, prior business experiences or history and evaluations. Suggestions can, but do not need to be, associated with observations and/or warnings.

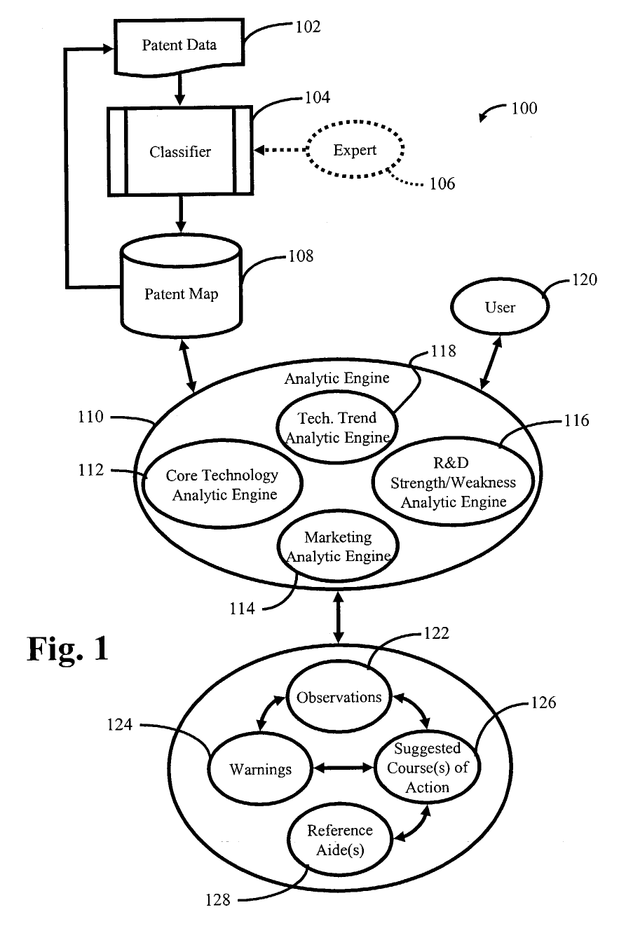

Illustrated in FIG. 1 is a block diagram of a system 100 of one embodiment of the present invention. System 100 has a patent map 108 that communicates with an analytic engine 110 and a plurality of patent-relate data 102. The patent map 108 is populated with patent-related information preferably extracted from the patent-related data 102. Patent-related data 102 can include, for example, patent-related document data associated with a reference entity (e.g., reference company) and any number of related entities (e.g., corporate subsidiaries or divisions) or unrelated entities (e.g., competitors.)

The patent map 108 can be populated via data extraction that is accomplished through a classifier 104. Alternatively, an expert 106 such as, for example, a patent attorney, engineer, or scientist, can be used in combination with or in lieu of classifier 104. Configured as such, patent-related data 102 is analyzed by classifier 104 and/or expert 106 such that each patent-related document is classified into one or more technological types and sub-types. All bibliographical information associated with the patent-related document including assignee or owner, filing date, issue date, priority date, inventor names, title of patent document, etc. is also preferably maintained, though this is not necessary and if desired only selected portions thereof needed for subsequent analysis can be maintained.

Once patent map 108 has been populated, analytic engine 110 uses patent map 108 as its processing information base. In this regard, analytic engine 110 has any one or more of four discrete engines including core technology analytic engine 112, marketing analytic engine 114, research and development (R&D) analytic engine 116, and technology trend analytic engine 118. A user 120 interfaces with analytic engine 110 to interact with any one or more of the analytic engines. A user interface allows user 120 to select or input criteria or information that defines a sub-set of the patent-related data 102 to be analyzed by any one or more of the analytic engines. Once the sub-set of the patent-related data to be analyzed has been defined, the selected analytic engine (e.g., 112, 114, 116, or 118) analyzes the associated patent-related documents according to the rules of the selected analytic engine to generate one or more outputs that can include observations 122, warnings 124, suggestions 126, and/or any associated reference aides 128.

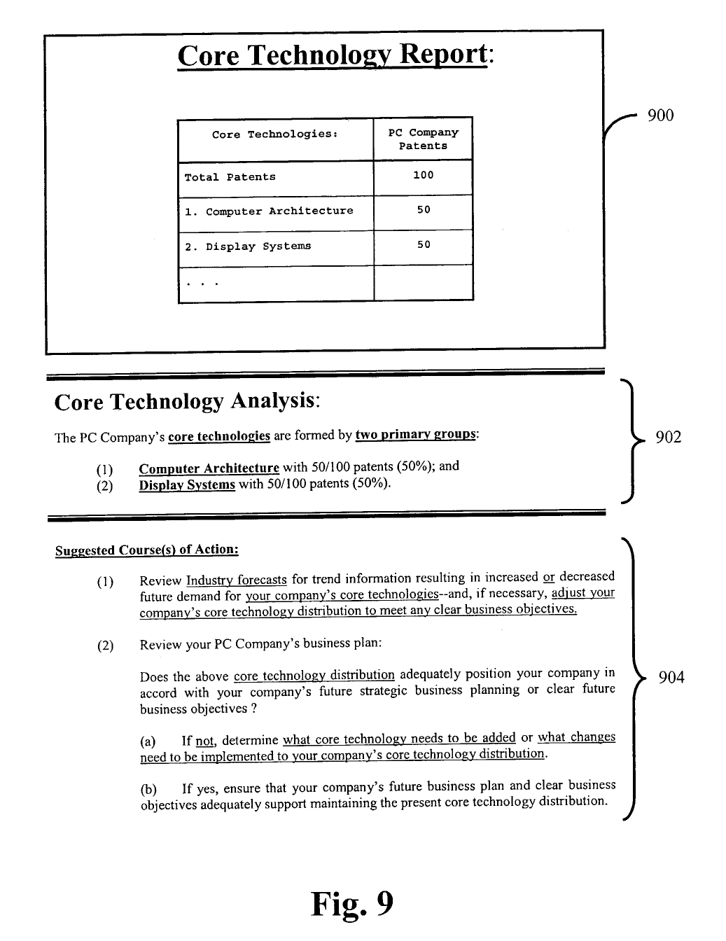

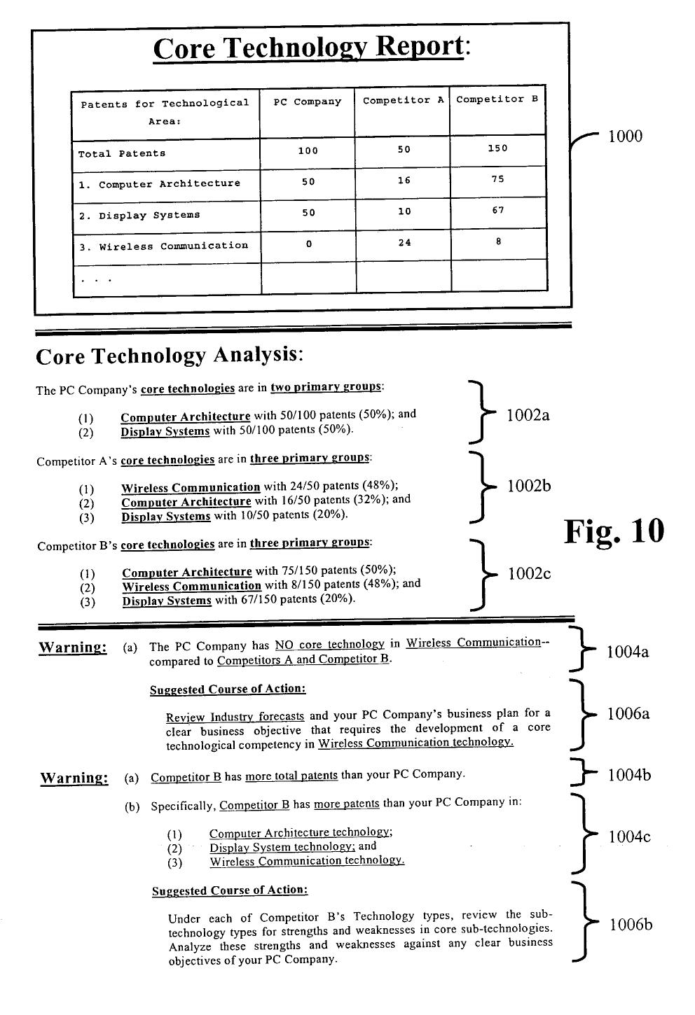

As will be described in more detail, observations 122 can include, for example, statistical information and factual deductions derived from the patent-related data. Warnings 124 can be generated from any of the following: a trend analysis, statistical information and/or factual deductions. For example, a warning or similar message can be generated when one or more competing entities have more patent documents than a reference entity in a technology group, a reference entity has a declining trend in the number of patent-related documents in a technology group, the reference entity has an unusual trend in the number of patent-related documents in a technology group, etc. Suggestions 127 including suggested courses of business action can be generated from any of the following: trend analysis, statistical information and/or factual deductions. Suggestions 126 can provide courses of business action for remedying or evaluating the trend analysis, statistical information and/or factual deductions. Suggestions 126 can be further associated with best business practices of a particular industry or technology sector. FIGS. 9-14 and Tables 1-18 further illustrate and provide examples of observations 122, warnings 124, suggestions 126, and reference aides 128.

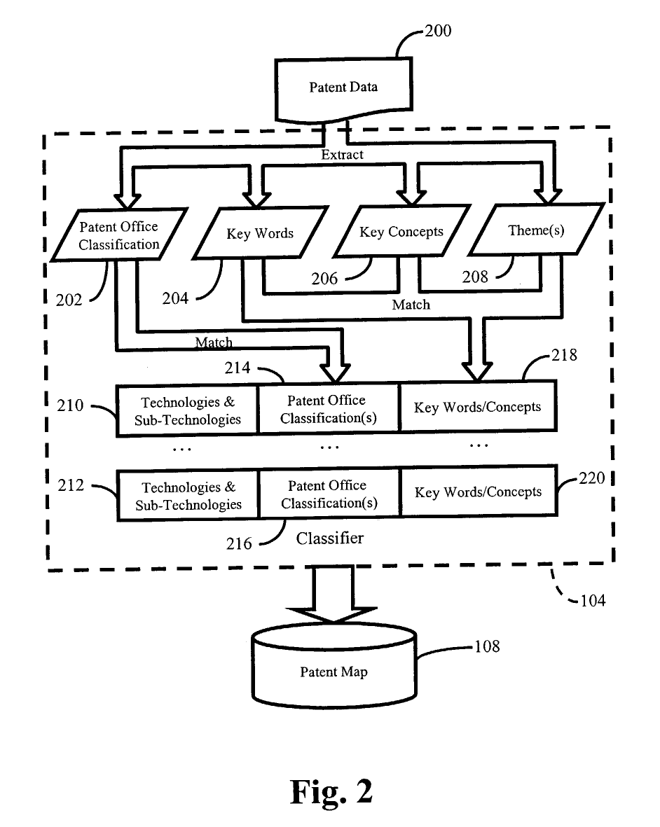

Referring now to FIG. 2, one embodiment of a classifier 104 is illustrated. This embodiment of classifier 104 extracts from a patent-related document 200 its patent office classification (if any) and, through a semantic analysis, its key words 204, key concepts 206, and themes 208. These extracted components are then matched to predefined technology and sub-technology definitions 210 through 212 that are characterized by patent office classifications 214 through 216, and key words, key concepts, and themes 218 through 220. As such, each patent-related document 200 is matched to its closest technology and sub-technology and accordingly entered into patent map 108. As described earlier, an expert 106 can be utilized in combination or in lieu of the above-described semantic analysis to generate the patent-related document's key words 204, key concepts 206, and themes 208. In alternate embodiments, the patent office classification 202 and/or the key words/concepts 206 and 208 can form the defined technology and sub-technology definitions or types.

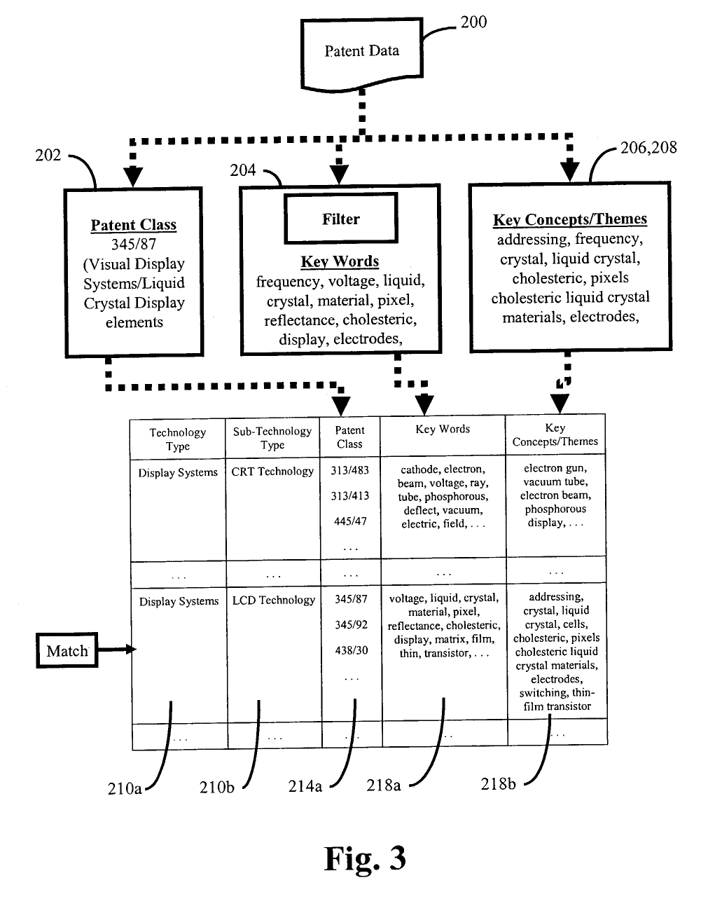

Referring now to FIG. 3, an example of the extraction and matching process for a particular patent-related document 200 will now be described. In this example, the patent class 202, key words 204, and key concepts and themes 206 and 208 have been extracted from the document 200. As shown, the extracted patent class is defined by a number combination “345/87” that corresponds to “Visual Display Systems/Liquid Crystal Display Elements,” based on the US Patent and Trademark Office patent classification system. Other classification systems including the International Patent Classification (IPC) system defined by the World Intellectual Property Office, or European Classification (ECLA) system can also be used.

In this example, the extracted key words 204 include “frequency, voltage, liquid, crystal, material, pixel, reflectance, cholesteric, display, and electrodes.” The extracted key concepts and themes 206 and 208 include “addressing, frequency, crystal, liquid crystal, cholesteric, pixels, cholesteric liquid crystal materials, and electrodes.” So extracted, these components are then matched to predefined technology and sub-technology identifiers. In this example, each technology and sub-technology is similarly described using one or more patent classifications, key words, and key concepts/themes. As shown in FIG. 3, one technology type is defined “Display Systems” that has two sub-technology types “CRT Technology” and “LCD Technology.” In this regard, each sub-technology type is defined by one or more patent classifications, key words, and key concepts/themes. Following the present example, it can be seen that patent document 200 most closely matches the patent classes 214a, key words 218a, and key concepts/themes 218b for the technology type of “Display Systems” 210a and the sub-technology type of “LCD Technology” 210b. Hence, patent document 200 populates database 108 under the technology of “Display Systems” and the sub-technology of “LCD Technology.”

A second embodiment of a classifier 104 includes extracting technology and sub-technology type information from the patent-related documents 200 themselves. This process includes a semantic analysis that analyzes the structure of each paragraph of the document 200. More specifically, the process extracts the first sentence of each paragraph of document 200 and applies a most frequently used word or phrase analysis, or a semantic key word or phrase analysis, to the extracted sentences. The first sentence of a paragraph often introduces the general topic of the paragraph. Hence, by extracting the general topics of each paragraph, a most used topics list can be generated, with the one topic most frequently used or the plurality of topics (based on a user defined threshold cut-off) most frequently used defining the technology type and/or sub-technology type of the document 200.

This approach can also be applied beyond the first sentence of each paragraph by including the second, third, fourth, etc., sentences of a paragraph and/or by including the last sentence or last sentences of a paragraph. The sentences of a paragraph after the first generally further describe the topic introduced by the first sentence. The last sentence or sentences of a paragraph generally either conclude a discussion of the topic introduced in the first sentence and/or transition between the topic introduced in the first sentence and the topic to be discussed in the next sentence. Therefore, by analyzing the sentence structure of each or selected paragraphs of patent document 200, the technology and sub-technology types can be generated therefrom. Documents having common topics can then be clustered or grouped together.

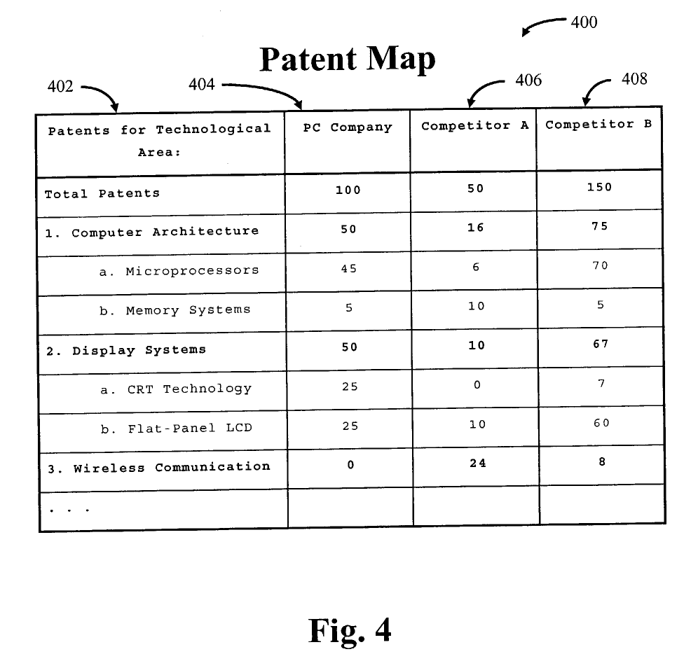

Illustrated in FIG. 4 is one embodiment of an information display 400 that can be generated by analytic engine 112. Display 400 includes a matrix or table having a first column 402 displaying all of the technology types or groups and sub-technology types or groups in database 108. Next to column 402, columns 404, 406, and 408 display the number of patent-related documents attributable to one or more entities for each technology and sub-technology type. As such, display 400 provides a wide snap-shop across various patenting entities of their patenting activities.

Display 400 can further include a merge function that allows a user to merge various patent assignees with each other. For example, very large entities having many business sub-divisions may have patent-related documents listed in association with the sub-division's name, which may or may not include the parent entity's name. The merge function allows a user to select one or more displayed entities and merge their data together. For example, in display 400, competitor B may really be a sub-division of competitor A or may be otherwise be related to competitor A. The merge function allows a user to select a parent entity (e.g., competitor A) and one or more related entities (e.g., competitor B) to be merged with the parent entity's data.

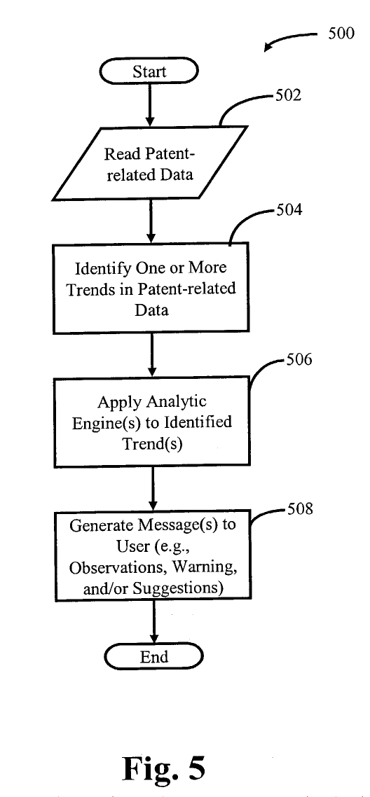

Referring now to FIG. 5, one embodiment of a flow diagram 500 analyzing patent-related data is shown. The rectangular elements denote processing blocks and represent computer software instructions or groups of instructions. The quadrilateral elements denote data input/output processing blocks and represent computer software instructions or groups of instructions directed the input or reading of data or the output of data. The flow diagrams shown and described herein do not depict syntax of any particular programming language. Rather, the flow diagrams illustrate the functional information one skilled in the art may use to fabricate circuits or to generate computer software to perform the processing of the system. It should be noted that many routine program elements, such as initialization of loops and variables and the use of temporary variables are not shown.

The logic starts in block 502 where patent-related data is read. As described, the patent-related data includes any data defining a patent-related document group and can include, for example, a technology type, sub-technology type, patent assignee, issue data, filing data, publication data, bibliographic data or selected portions thereof, merged data, or any combinations of the aforementioned. This data can also include one or more selected analytic engines.

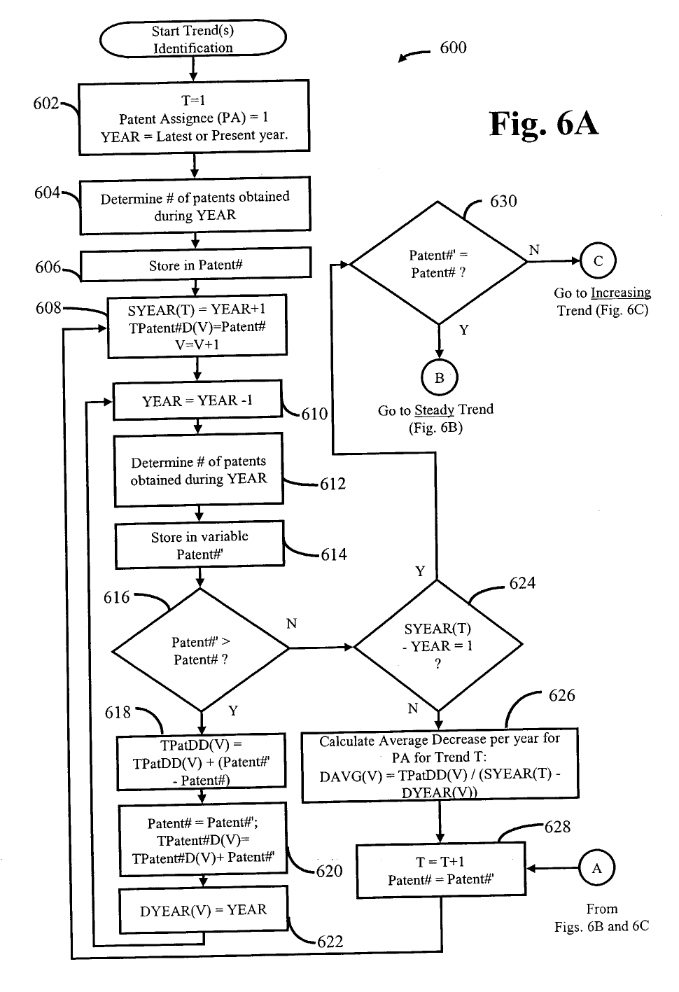

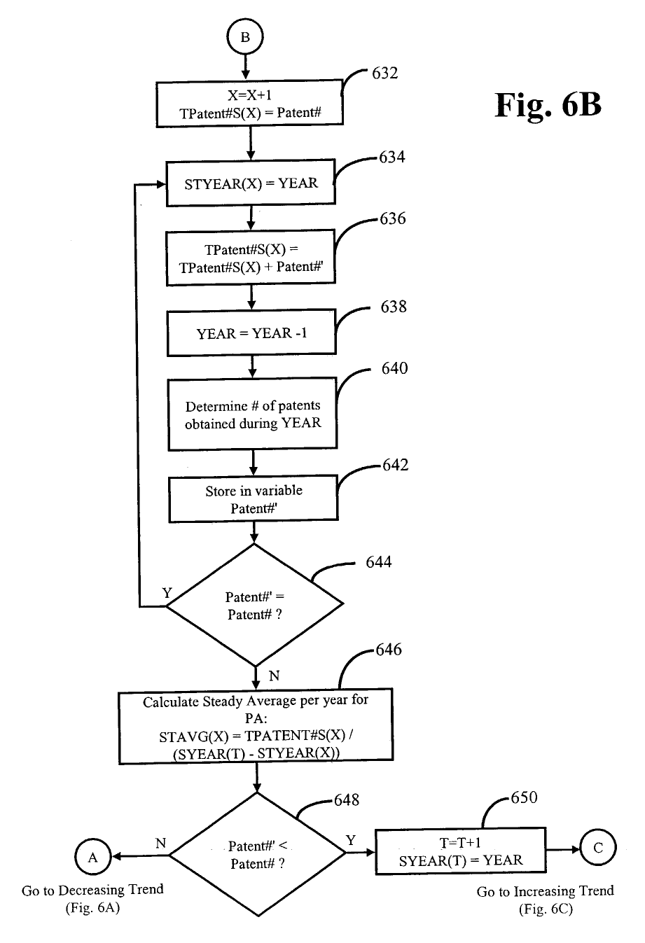

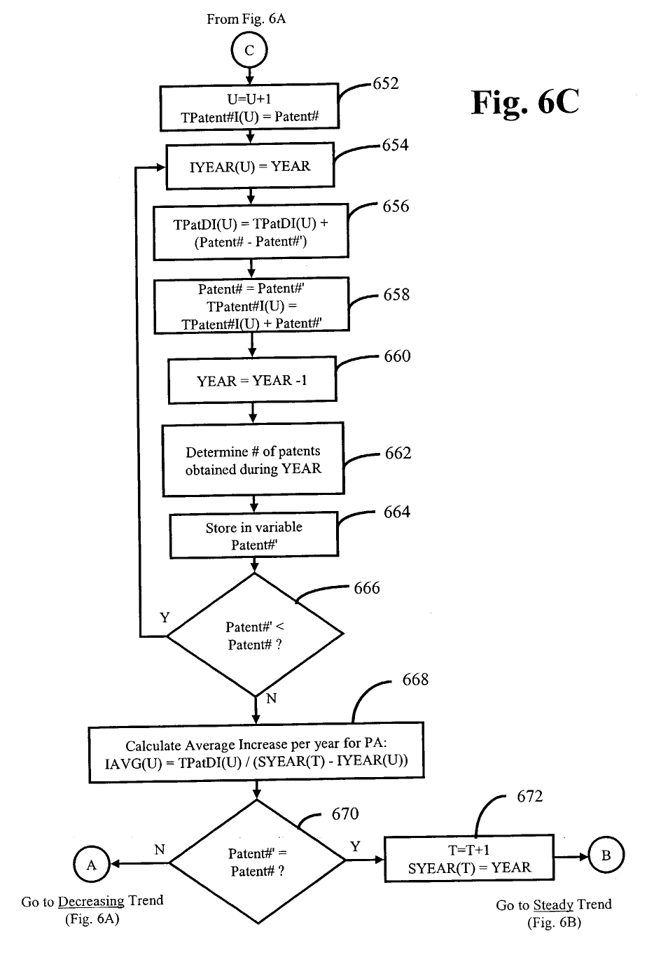

In block 504, one or more trends in the patent-related data are identified. The trends can include, for example, the number of patent-related documents in a particular technology type and/or sub-technology type received over time or selected time periods, increasing, decreasing, and/or steady trends in the patent-related data or documents over time or selected time periods, and comparisons of the aforementioned with each other. FIGS. 6A, 6B, and 6C further illustrate one detailed embodiment of trend identification.

Once the trends have been identified, the selected analytic engines analyze the trends and other patent-related data in block 506 and generate therefrom in block 508 outputs associated with one or more observations, warnings, suggestions, or combinations thereof. As will be described, these observations, warnings, and suggestions are associated with the selected analytic engines. The same identified trends and other patent-related data can be input into one or more analytic engines so as to provide a broader analysis. A single analytic engine may also be selected if desired. This flow can be executed as many times as desired and on as many trends as desired by a user.

Illustrated in FIGS. 6A, 6B and 6C are embodiments of flow diagrams analyzing and identifying trends from patent-related data. In this embodiment, all increasing, decreasing, and/or steady trends in the patent-related data can be identified, along with each trend's starting year, ending year, and statistical information associated with the trend. Also in this embodiment, the trends can be associated with particular patent assignees, technology types, sub-technology types, and combinations thereof. The association is defined by user input data that is read. Also, references hereinafter in connection with the description of FIGS. 6A, 6B and 6C will be made to “present year” and “previous year.” For clarity, these references are made within the context the “present year” and “previous year” analyzed. For example, the year 2002 may be the “present year” being analyzed and the year 2003 may be the “previous year” being analyzed.

Block 602 starts by initializing a count variable for the total number of trends “T” exhibited by a first patent assignee “PA=1” and the latest or present year “YEAR” in the analysis. Block 604 counts the number of patent-related documents associated with the present year by the patent assignee based on the input data, which can include the designation of a particular technology or sub-technology type. The number of patent-related documents associate with any year can be based on publication dates, issue dates, priority dates and/or filing dates. Block 606 stores the count in a variable. Block 608 creates variables for tracking the start year of the current trend “SYEAR(T),” the number of decreasing trends “V” in the analysis and the total number of patent-related documents associated with the current decreasing trend “TPatent#D(V).” Block 610 decrements the year so that the decremented year becomes the present year being analyzed and blocks 612 and 614 determine the number of patent-related documents associated with the decremented year and stores the value in a variable. Block 616 determines if the trend associated with the present year (decremented year) and the previous year is a decreasing trend by determining if the number of patent-related documents associated with the present year is greater than the number of patent documents associated with the previous year. If this condition is true, then there is a decreasing trend between the present year being analyzed and the previous year and the flow proceeds to block 618 where the summation of patent-related document differences “TPatDD(V)” between years is calculated. Block 620 stores the value of the number documents for the present year in the variable for the previous year in preparation for the next year decrement and maintains a summation of total number of documents for the current decreasing trend. Block 622 updates a variable representing the starting year “DYEAR(V)” of the present decreasing trend with the present year analyzed. After block 622, the flow loops back to step 610 where the year is decremented again and the flow checks to see if the decreasing trend is maintained by the decremented year having a greater number of patent-related documents associated therewith compared to the previous year, as described above. This loop continues until the decremented year has either the same (indicating the steady trend) or less (indicating an increasing trend) number of patent-related documents compared with the previous year. Either condition indicates the completion of the decreasing trend identification.

These conditions are satisfied if the decision to block 616 is negative, whereupon flow proceeds to block 624. Block 624 checks to determine of the difference between the trend start year “SYEAR(T)” and the present year “YEAR” is equal to one, which indicates that a trend other than a decreasing trend is initially present. If the condition of block 624 is affirmative, the flow branches to block 630 to determine whether a steady trend or increasing trend is present. If the condition of block 624 is negative, the decreasing trend analysis is completed in blocks 626 and 628. Block 626 calculates the average decrease per year “DAVG(V)” for this particular decreasing trend. Since identification of the decreasing trend is now complete, block 628 increments the total trend count “T” for the next trend to be identified and updates the variable storing the document total for present year. After block 628, the flow loops back to block 608 to start the trend identification process for the next trend.

As described above, if the patent-related document totals associated with consecutive years do not indicate that a decreasing trend is present in block 616, the flow reaches block 630 and determines whether a steady or increasing trend in patent-related documents is present. A steady trend is present if the patent-related document totals for the present year and the previous year are the same. If they are not, then an increasing trend is present. If a steady trend is present, then the flow proceeds to block 632.

Block 632 initializes a steady trend counter “X” and a variable for maintaining the total number of patent-related documents for the identified steady trend. Block 634 initializes a variable “STYEAR(X)” that identifies the starting year of the identified steady trend. Block 636 sums the total number of patent-related documents for this particular steady trend and block 638 decrements the present year being analyzed. Blocks 640 and 642 determine the number of patent-related documents associated with the present year (now decremented) and stores it in a variable. Block 644 checks to see of the steady trend is satisfied by comparing the number of patent-related documents associated with the present year with the number associated with the previous year. If the numbers are the same, a steady trend exists and the flow loops back to block 634 where it updates the year defining the starting year for the present steady trend and continues the identification and analysis. If the numbers are not the same in block 644, then the steady trend indentification is completed in block 646. Block 646 calculates the steady average “STAVG(X)” number or patent-related documents per year for this particular steady trend. After block 646, the flow proceeds to block 648 where the next trend is identified.

In block 648, if the number of patent-related documents associated with the present year is not less than the number associated with the previous year analyzed, then a decreasing trend is identified and the flow proceeds to block 628 and begins identification and analysis of the new decreasing trend. If in block 648 the number of patent-related documents associated with the present year is less than the number associated with the previous year analyzed, then a new increasing trend is present and the flow proceeds to block 650. In block 650, the trend counter “T” is incremented and the trend starting year initialized with the present year.

Block 652 initializes an increasing trend counter “U” and a variable for maintaining the total number of patent-related documents for the identified increasing trend. Block 654 initializes a variable “IYEAR(U)” that identifies the starting year of the identified increasing trend. Block 656 sums the differences in number of patent-related documents between consecutive years for this particular increasing trend. Block 658 stores the present year's number of patent-related documents in the variable for the previous year and sums the total number of patent-related documents over the years for the increasing trend. Block 660 decrements the present year being analyzed to the next year. Blocks 662 and 664 determine the number of patent-related documents associated with the present year (now decremented) and stores it in a variable. Block 666 checks to see of the increasing trend is satisfied by comparing the number of patent-related documents associated with the present year with the number associated with the previous year. If the present year total is less than the previous year total, an increasing trend exists and the flow loops back to block 654 where it updates the year defining the starting year for the present increasing trend and continues the identification and analysis. If the total for the present year is not less than the total for the previous year in block 666, then the increasing trend identification is completed in block 668. Block 668 calculates the average increase per year “IAVG(U)” in the number or patent-related documents for this particular increasing trend. After block 670, the flow proceeds to block 648 where the next trend is identified.

In block 670, if the number of patent-related documents associated with the present year is not the same as the number associated with the previous year analyzed, then a decreasing trend is present and the flow proceeds to block 628 and begins identification and analysis of the new decreasing trend. If in block 648 the number of patent-related documents associated with the present year is the same as the number associated with the previous year analyzed, then a new steady trend is present and the flow proceeds to block 672. In block 672, the trend counter “T” is incremented and the trend starting year initialized with the present year. After block 672, the flow proceeds to block 632 where the steady trend is analyzed, as described above.

In this manner, the flow of FIGS. 6A, 6B, and 6C can continue until all of the trends for a particular set of patent-related data have been identified. Nevertheless, it is not necessary for all of the trends to be identified. Instead, one or more trends such as, for example, the recent most trend that incorporates the last or most recent year can be identified and analyzed since it can present significant information about the present state of business affairs of a particular patent assignee. Some portion or all of the identified trend data can be used by the analytic engines to provide informational outputs associated with observations, warnings, suggestions, or combinations thereof to assist in the strategic decision-making process.

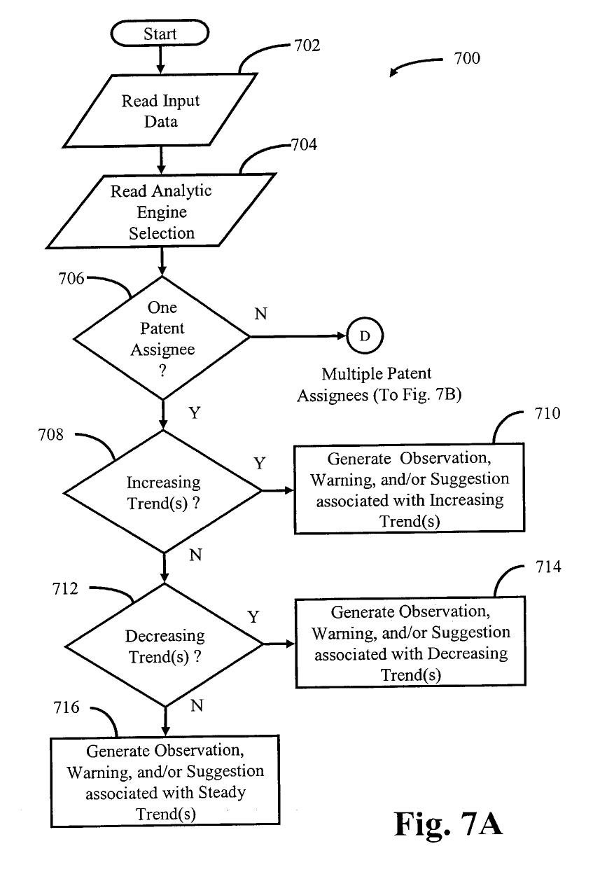

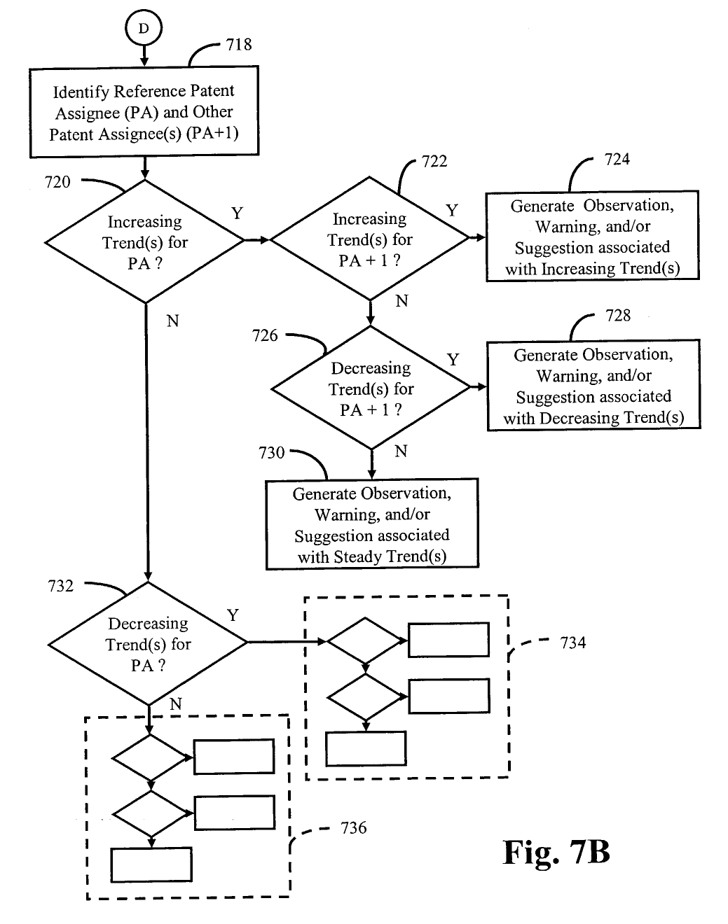

FIGS. 7A and 7B are embodiments of a flow diagram 700 that generates informational outputs based on trends associated a single patent assignee or, in the case of multiple patent assignees, informational outputs based on a comparison of trends associated with a reference patent assignee and one or more other patent assignees. The flow starts in block 702 where the patent-related data is read. As described above, this can include the same patent-related data input into the trend identification flow or a sub-set thereof and can also include the entire trend identification data or a subset thereof. Block 704 reads the analytic engine selection, which can include the selection of one or more analytic engines for analyzing the trends. Block 706 determines if only one patent assignee is present in the patent-related data or multiple patent assignees. If only one patent assignee is present, the flow proceeds to blocks 708, 710, 721, 714, or 716 where it is determined from the trend identification data whether the identified trend is an increasing trend (block 708), decreasing trend or steady trend (block 712). If the trend is an increasing trend in block 708, then the flow proceeds to block 710 were outputs are generated that are associated with one or more observations, warnings, and/or suggestions dealing with an increasing trend for the selected analytic engine(s). If the trend is a decreasing trend in block 712, then the flow proceeds to block 714 were outputs are generated that are associated with one or more observations, warnings, and/or suggestions dealing with a decreasing trend for the selected analytic engine(s). Similarly, if the trend is a steady trend in block 712, then the flow proceeds to block 716 were outputs are generated that are associated with one or more observations, warnings, and/or suggestions dealing with a steady trend for the selected analytic engine(s).

If multiple patent assignees are present, then the logic advances from block 706 to block 718 where a reference patent assignee “PA” is identified. This identification is preferably accomplished by reading a user input selection designating one or more reference patent assignees in the patent-related data. Once a reference patent assignee “PA” is identified in block 718, the flow proceeds as needed to blocks 720, 722, 724, 726, 728, 730, 732, 734, and 736. In this regard, the flow compares the most recent trend (i.e., increasing, decreasing, or steady) of the reference patent assignee “PA” with the most recent trend (i.e., increasing, decreasing or steady) of one or more of the other patent assignees “PA+1” and generates the appropriate observations, warnings, and/or suggestions associated with the particular combination of trends present (blocks 724, 728, 730, 734, and 736.) For sake of clarity, blocks 734 and 736 include a similar analysis but are branched to from block 732, which determines whether the reference patent assignee “PA” has a decreasing or steady trend. Hence, based on a comparison of the reference patent assignee's trend to another patent assignee's trend, each analytic engine can provide one or more observations, warnings, and suggestions suited to the particular trend comparison. The various types of trend comparisons and the types of output observations, warnings, and/or suggestions for each analytic engine are described in greater detail in connection with FIGS. 9-14 and Tables 1-18.

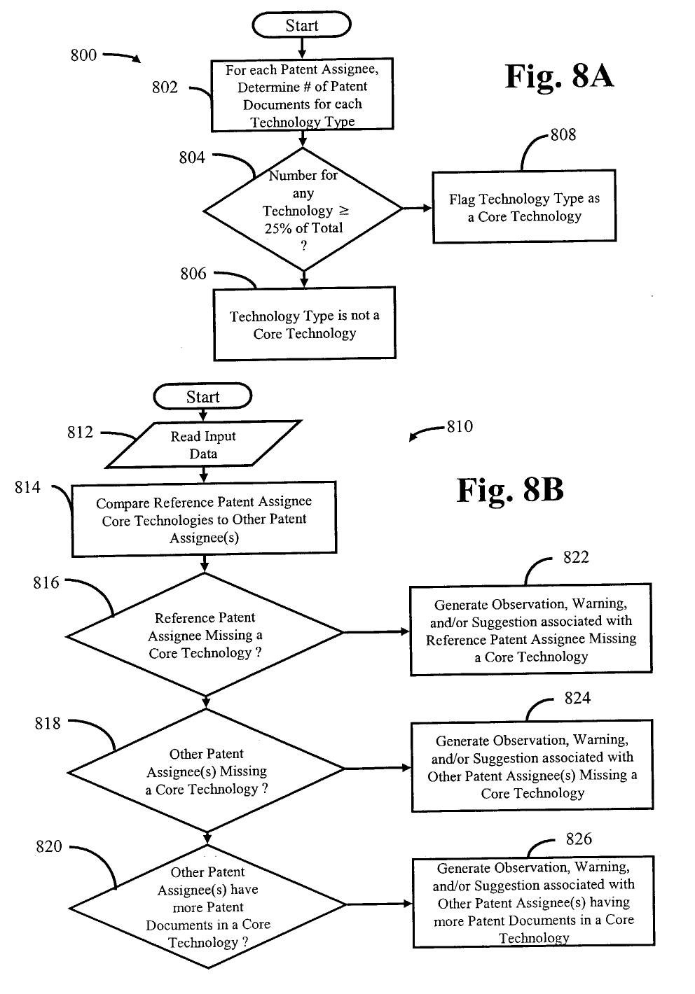

Illustrated in FIGS. 8A and 8B are embodiments 800 and 810 of flow diagrams generating informational outputs based on core technology trends associated with the patent-related data. FIG. 8A relates to the identification process for core technologies and FIG. 8B relates to a comparison of identified core technologies between a reference patent assignee “PA” and one or more other patent assignees “PA+1”. In FIG. 8A, the flow starts in block 802 where it determines the number of patent-related documents in each technology type and the total number of number patent-related documents associated with a patent assignee. Block 804 determines if a particular technology type is a core technology by comparing its total number of documents versus a core technology threshold value of, for example, 25% of the total number of documents. This threshold value can be modified to include any reasonable percentage of the total number of documents. If the total number of documents for the technology type is greater than or equal to this threshold, then the technology type is flagged as a core technology in block 808. If the number of documents for the technology type is less than this threshold, then in block 806 the technology type is either not flagged or flagged as not being a core technology. This is preferably performed for each technology type and each patent assignee, though the analysis can be limited to selected sub-sets of one or more technology types and one or more patent assignees.

FIG. 8B compares identified core technologies between a reference patent assignee “PA” and one or more other patent assignees “PA+1”. Block 812 reads patent-related data that can include technology types associated with one or more patent assignees that have been flagged as core technologies. This data preferably includes data identifying a reference patent assignee “PA” and can further include data identifying one or more other patent assignees. Blocks 814, 816, 818, and 820 compare the core technologies of the reference patent assignee to the core technologies of each of the one or more other patent assignees. If the reference patent assignee is missing a core technology (block 816), then an output is generated (block 822) that can include one or more observations, warnings, and/or suggestions to that effect. If one of the other patent assignee's is missing a core technology (block 818) of the reference patent assignee, an output is generated (block 824) that can include one or more observations, warnings, and/or suggestions to that effect. Also, if one or more of the other patent assignees have more patent-related documents than the reference patent assignee in a common core technology (block 820), then an output is generated (block 826) that can include one or more observations, warnings, and suggestions to that effect. Other comparisons can be similarly formulated addressing whether the reference patent assignee has more patent-related documents than one or more of the other patent assignees in a common core technology. As mentioned above, the various types of trend comparisons and the types of output observations, warnings, and/or suggestions for each analytic engine, including the core technology analytic engine, are described in greater detail in connection with FIGS. 9-14 and Tables 1-18.

Referring now to FIG. 9, one embodiment of core technology report output is illustrated. In this regard, the display includes matrix 900 showing the reference patent assignee's patent-related document totals for each technology and sub-technology type. Also displayed are observations 902 that include, for example, factual deductions and statistical information. More specifically, the factual deduction in this embodiment is based on the statistical information that 50% of the reference entity's patents fall within a first technology “Computer Architecture” and 50% fall within a second technology “Display Systems.” Hence, reference patent assignee's core technologies lie primarily within two technology types. Based on this information, two courses of business actions 904 are suggested. The first suggestion is a review of industry forecasts for information that indicates increased or decreased future demand for the reference patent assignee's identified core technologies—and, if necessary, an adjustment of the reference patent assignee's core technology distribution to meet any clearly defined business objectives. The second suggested course of business action recommends a review of the reference patent assignee's business plan to determine if the present core technology distribution adequately positions the reference patent assignee in accord with the entity's future strategic business objectives. As shown, the second suggested course of business action further includes several follow-up suggested courses of business actions in addition to the main suggestion.

FIG. 10 illustrates a more detailed example of a core technology analytic engine report output. More specifically, the display includes matrix 1000 showing the reference patent assignee's and two competing patenting assignee's patent-related document totals for each defined technology and sub-technology type. Also displayed are observations 1002a, 1002b, and 1002c that include, for example, factual deductions and statistical information regarding each of the patenting entities. As described earlier, the factual deductions can be based on the statistical information and can take the form of a statements indicating each patenting entity's core technologies lie within one or more technology types.

For example, observation 1002a includes the factual deduction that the PC Company's core technologies lie within two technology groups “Computer Architecture” and “Display Systems.” Observation 1002a also indicates a statistical breakdown showing that 50% of the patent-related documents are in the technology group of “Computer Architecture” and 50% are in the technology group of “Display Systems.” Similarly, Observations 1002b and 1002c include factual deductions and statistical breakdowns for Competitors A and B.

As described earlier, one or more warnings can also be generated and displayed based any core technology information including, for example, a warning that one or more competing patent assignees have more patent-related documents than the reference patent assignee in the one or more core technologies. In FIG. 10, warnings 1004a and 1004b are generated. Warning 1004a is generated because the reference PC Company has no patent-related documents in the technological type “Wireless Communication,” compared to competitors A and B. Warning 1004b is generated because the reference PC Company has less total patent-related documents compared to competitor B in the one ore more technology types. An associated sub-display 1004c is also generated specifically listing the technology types where the referenced PC Company has less patent-related documents than competitor B.

In the embodiment of FIG. 10, suggested courses of business actions 1006a and 1006b are generated in association with warnings 1004a, 1004b, and 1004c. In this regard, warning 1004a is generated because the reference PC Company has no patent-related documents in the technological type “Wireless Communication,” compared to competitors A and B. In response, suggested course of business actions 1006a displays that a review of industry forecasts for wireless communications is appropriate. Suggested course of business actions 1006a also displays a suggestion that a review of the referenced PC Company's business plan for a clear business objective that requires a core technological competency in wireless communications technology is also appropriate. Moreover, further suggestions can be generated based on the indicated courses of business action that would be appropriate from such reviews. For example, if industry forecasts predict a dramatic rise in demand for wireless technologies and the referenced PC company's business plan indicates that there is a clear business objective that can be met by such a core technical competency, then a suggested course of business action would be generated as to how the referenced PC Company can acquire or generate such a core technical competency.

Suggested course of business action 1006b is generated in response to the warning that the reference PC Company has less total patent documents compared to competitor B in the defined technology types. More specifically, suggested course of business action 1006b generates a display that suggests a review of sub-technological types under each technological type is appropriate to reveal strengths and weaknesses in competitor B's core sub-technologies. This review can be accomplished by “clicking” on any of the information fields within matrix 700 to drill down into the core sub-technologies of each patent assignee. Such drilling down generates more detailed information about the core sub-technologies and patent-related documents including, for example, detailed and summary information regarding each patent document (including text and images). Similarly, in any display of the observations, warnings, and suggested courses of business actions, “clicking” on or “drilling down” into the displayed technology or sub-technology type reveals more detailed information about the patent-related documents falling under these definitions. Such navigations features are common to all of the displays described herein. Once the strengths and weaknesses have been brought to light, the suggested message advises that they be compared to the clear business objectives of the reference PC Company to determine impacts thereof.

Hence, the core technology analytic engine helps a user to understand and evaluate the core technological competencies of one or more patent assignees and where they may lie. The core technology analytic engine also helps a user to understand how deficiencies in core technological competencies can be identified and remedied and how advantages in core technological competencies can be capitalized on.

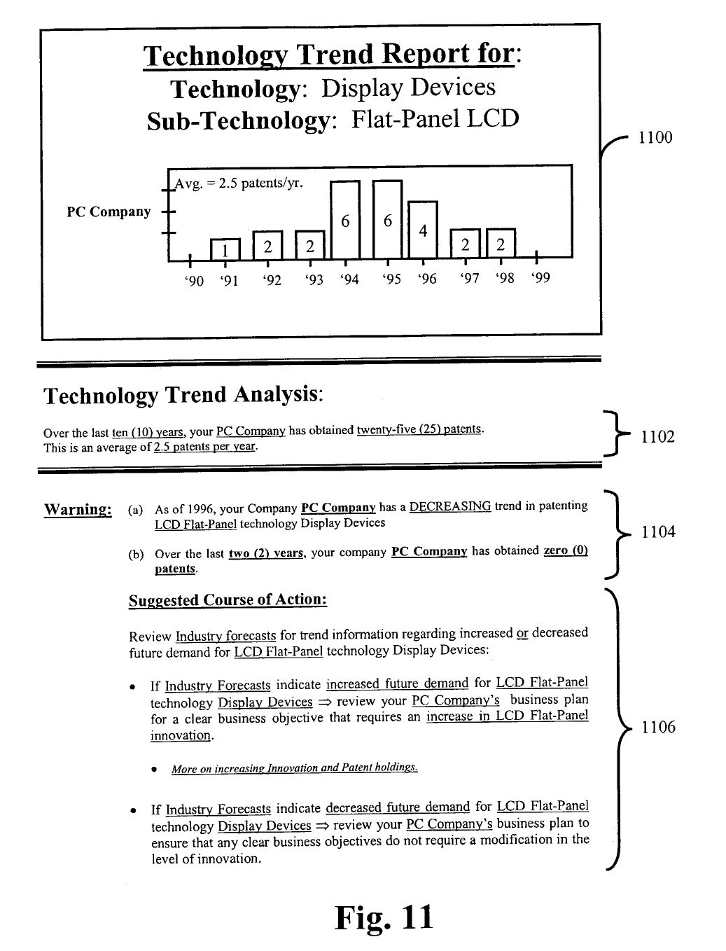

Illustrated in FIG. 11 is one embodiment of technology trend report output. This embodiment illustrates a technology trend analytic report for a reference patent assignee “PC Company,” for the technology type “Display Devices,” sub-technology type “Flat-Panel LCD,” and time period spanning from 1999 reaching back to 1990. In this regard, the display includes a graphics area 1100 visually depicting the number of matching patent-related documents over the defined 10 year period. In this particular embodiment, graphics area 1100 depicts this information through an interactive bar chart display that displays the number of matching patent-related documents on a per year basis. A user can drill down into each of the years to learn more about the matching patent documents by simply clicking on any of the bars. This feature is also common to all of the outputs described herein. Also shown in graphics area 1100 is a calculated average number of patent documents per year. Hence, graphics area 1100 provides a plurality of information outputs that can be quickly and easily comprehended.

Also displayed are observations 1102 that include, as described above, factual deductions and statistical information relating to the analyzed patent-related data. In particular, the factual deductions in this embodiment include a first statement that over the last ten (10) years the referenced PC Company has obtained twenty-five (25) patent documents. A second statement describes that over this time period the referenced PC Company has averaged 2.5 patent documents per year. Other statements and deductions can also be made.

Based on the information represented by the analyzed patent-related data, one or more warnings are generated. In this embodiment, warning 1104 is generated that includes first and second warnings. The first warning describes that as of the year 1996, the referenced PC Company has exhibited a decreasing trend in generated or obtaining patent documents relating to the sub-technology of “LCD Flat-Panel” display devices. The second warning specifically describes the observation that over the last two (2) years, the referenced PC Company has obtained or generated zero (0) patent documents.

In response to warning 1104, suggested courses of business action 1106 are generated. In this embodiment, suggested courses of business action 1106 include a review of industry forecasts for information indicative of increased or decreased future demand for the sub-technology group of “LCD Flat-Panel” displays. Sub-sets of suggested courses of business action are also generated and displayed that provide guidance as what courses of business actions should be pursued if the industry forecasts indicate either increased or decreased future demand for the technology. Additionally, links to reference materials providing further resources on business actions such as, for example, a link to a treatise or other electronic reference on how to increase innovation and patent holdings can also be generated and displayed.

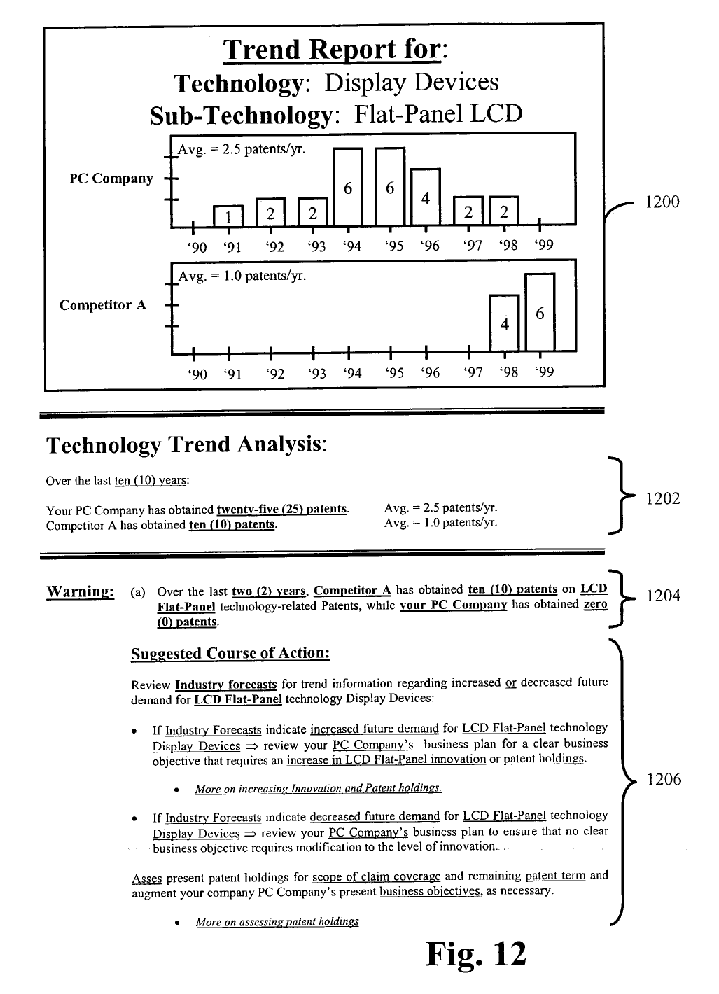

Illustrated in FIG. 12 is another embodiment of technology trend report output, This embodiment illustrates a technology trend analytic report for a reference patent assignee “PC Company” and a competing patent assignee “Competitor A,” for the technology type “Display Devices,” sub-technology type “Flat-Panel LCD,” and time period spanning from 1999 reaching back to 1990. In this regard, the display includes a graphics area 1200 visually depicting the number of matching patent-related documents over the defined 10 year time period for each patent assignee. As in the embodiment of FIG. 11, this information can be depicted through an interactive bar chart display that displays the number of matching patent-related documents on a per year basis.

Further displayed are observations 1202 that include, as described above, factual deductions and statistical information associated with the analyzed patent-related data. In particular, the factual deductions in this embodiment include a first statement that over the last ten (10) years the referenced PC Company has obtained twenty-five (25) patent documents and second statement that competitor A has obtained ten (10) patent documents, along with per year averages. Other statements and deductions can also be made under this data scenario.

Based on the analysis of the patent-related data, one or more warnings are generated. In this embodiment, warning 1204 is generated. Warning 1204 describes that over the last two (2) years, competitor A has generated or obtained ten (10) patent-related documents on “LCD Flat-Panel” display technology, while the referenced PC Company has obtained only two (2) patents. As a result of warning 1204, suggested courses of business action 1206 are generated, which are similar to suggested courses of business actions 1106, which direct an industry forecast analysis for increased or decreased future demand for “LCD Flat-Panel” display technology.

However, suggested courses of business action 1206 also include a suggestion that an assessment of the present patent-related documents owned the reference patent assignee PC Company be performed. This analysis can include, for example, a determination of the scope of legal protection and the remaining term of the patent-related documents. The goal of such an analysis is to determine whether the referenced patent assignee's present patent-related documents necessitate an augmentation to the PC Company's business plans.

Therefore, the technology trend analytic engine helps a user to understand and evaluate the technological trends of one or more patent assignees and the direction they may be heading. The technology trend analytic engine also helps a user to understand how deficiencies in a patent-assignee's technological trends can be identified and remedied and how advantages in technological trends can be benefited from.

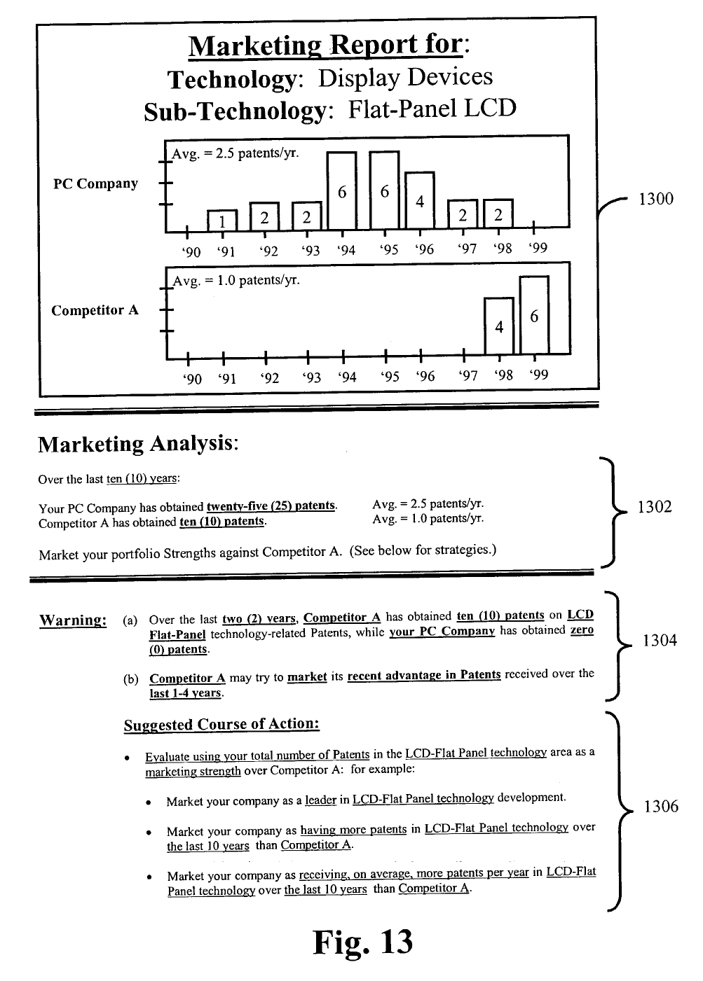

Illustrated in FIG. 13 is one embodiment of marketing report output. This embodiment illustrates a marketing analytic report for a reference patent assignee “PC Company” and a competing patent assignee “Competitor A,” for the technology type “Display Devices,” sub-technology type “Flat-Panel LCD,” and time period spanning from 1999 reaching back to 1990. Similar to FIG. 12, the display includes a graphics area 1300 visually depicting the number of matching patent documents over the defined 10 year time period for each patent assignee. As in the embodiments of FIGS. 11 and 12, this information can be depicted through an interactive bar chart display that displays the number of matching patent documents on a per year basis.

In this regard, the embodiment of FIG. 13 also has observations 1302 that include, as described above, factual deductions and statistical information relating to the analyzed patent-related data. In particular, the factual deductions in this embodiment include a first statement that over the last ten (10) years the referenced PC Company has obtained twenty-five (25) patent documents and second statement that competitor A has obtained ten (10) patent documents, along with per year averages. Observations 1302 also include a statement that since the referenced PC Company has more patent documents over the defined time period than competitor A, the referenced PC Company should market this strength over competitor A. Other statements and deductions can also be made as observations under this same data.

As described above, based on the information represented analyzed patent-related data, one or more warnings are generated. In this embodiment, warning 1304 is generated and includes first and second sub-warnings. The first sub-warning describes that over the last two (2) years, competitor A has generated or obtained ten (10) patent documents on “LCD Flat-Panel” display, while the referenced PC Company has obtained only two (2) patents. The second sub-warning describes that competitor A may try to market its recent advantage in patent documents over the last one (1) to four (4) years.

In connection with these warnings, suggested courses of business action 1306 are generated. These suggested courses of business action suggest that the referenced PC Company evaluate using its total number of patent-related documents in the “LCD Flat-Panel” display technology as a marketing strength over competitor A. Connected therewith, one or more additional suggestions are generated and displayed including marketing the referenced PC Company a leader in “LCD Flat-Panel” display technology, marketing the referenced PC Company as having more patent documents over the last ten (10) years than competitor A, and/or market your company as receiving on average over the last ten (10) year more patents than competitor A. Other suggestions can also be generated and displayed from this data scenario.

As a result, the marketing analytic engine helps a user to understand and evaluate the marketing position of one or more patent assignees from a technology perspective. The marketing analytic engine also helps a user to understand how deficiencies in a patent-assignee's technological trends can be associated with marketing weaknesses and how strengths in technological trends can be associated with marketing benefits.

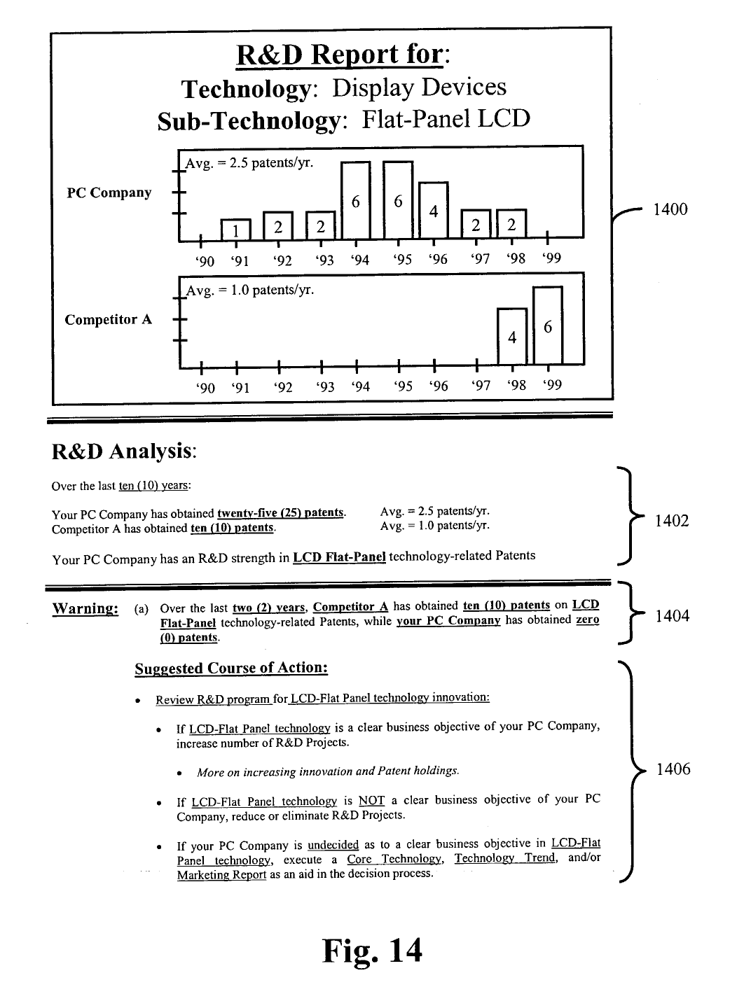

Illustrated in FIG. 14 is one embodiment of research and development report output. This embodiment illustrates a research and development (R&D) analytic report for a reference patent assignee “PC Company” and a competing patent assignee “Competitor A,” for the technology type “Display Devices,” sub-technology type “Flat-Panel LCD,” and time period spanning from 1999 reaching back to 1990. Similar to FIGS. 12 and 13, the display includes a graphics area 1400 visually depicting the number of matching patent documents over the defined 10 year time period for each patenting entity. As in the embodiments of FIGS. 11, 12, and 13, this information can be depicted through an interactive bar chart display that displays the number of matching patent documents on a per year basis.

Observations 1402 are displayed that include, as described above, factual deductions and statistical information relating to the analyzed patent-related data. In particular, the factual deductions in this embodiment include a first statement that over the last ten (10) years the referenced PC Company has obtained twenty-five (25) patent documents and second statement that competitor A has obtained ten (10) patent documents, along with per year averages. Observations 1302 also include a statement that since the referenced PC Company has more patent documents over the defined time period than competitor A, the referenced PC Company presumably has a research and development strength over competitor A. Other statements and deductions can also be made as observations in this scenario.

As described earlier, based on the information represented by the analyzed patent-related data, one or more warnings are generated. In this embodiment, warning 1304 is generated and describes that over the last two (2) years, competitor A has generated or obtained ten (10) patent documents on “LCD Flat-Panel” display technology, while the referenced PC Company has obtained only two (2) patents. Closely connected with warning 1304, one or more suggested courses of business actions 1306 are generated.

More particularly, suggested courses of business action 1306 include a suggestion that the referenced PC Company review its research and development program for “LCD Flat-Panel” display technology development. In this regard, several follow-up suggestions are also generated including suggestions that if “LCD Flat-Panel” display technology is a clear business objective, then the referenced PC Company must increase its level of research and development in view of the warning. Another follow-up suggestion includes considering a reduction in the level of research and development if “LCD Flat-Panel” display technology is not a clear business objective of the referenced PC Company. Yet another suggestion includes running a core technology analytic report to help determine if “LCD Flat-Panel” display technology should be a clear business objective. Other suggestions can also be made in view these circumstances.

Therefore, the research and development analytic engine helps a user to understand and evaluate the research and development efforts of one or more patent assignees and in what technologies such efforts may be focused. The research and development analytic engine also helps a user to understand how deficiencies in a patent-assignee's research and development efforts can be identified and remedied and how advantages in research and development efforts can maximized.

Tables 1-18, which appear at the end of these specification provide a more detailed and structured description of the various observations, warnings, and suggested courses of business action that can be generated based on identified tends in the patent-related data and selected analytic engines. Tables 1-5 describe conditions that generate observations, warnings and suggestion according to the technology trend analytic engine. Tables 6-10 describe conditions that generate observations, warnings and suggestions according to the marketing analytic engine. Tables 11-15 describe conditions that generate observations, warnings and suggestions according to research and development analytic engine. Tables 16-18 describe conditions that generate observations, warnings and suggestions according to the core technology analytic engine. It has been the intent of this specification to illustrate via examples the multitude of observations, warnings, suggestions, analyses and the conditions that give rise to the same to further the understanding of the invention. It is not the intent of such descriptions to in any way limit the scope of the specification and attached claims. Connected therewith, it should be clear that based on the teachings herein, many other observations, warnings, suggestions, and analytic engines can be formulated.

So configured, a patent-centric system and method for assisting corporate decision makers and others in making strategic business decisions involving technology is described. Analytic engines are provided that include, for example, core technology analysis, marketing analysis, research and development analysis, and technology trend analysis based on patent-related data that includes patent-related document information. The patent-related document information can been classified or grouped into meaningful technology categories that are easily understood by the users. With this example system, the analytic engine analyzes the patent-related document information to generate interactive displays reporting the results of the analysis. The results of the analysis can include, for example, one or more observations, warnings, and suggested courses of business actions to assist the user in making any required technologically-related strategic business decisions.

The system and method of the present invention can be implemented on a variety of platforms including, for example, networked computer systems and stand-alone computer systems. Additionally, the logic and databases shown and described herein preferably reside in or on a computer readable medium such as, for example, a Read-Only Memory (ROM), Random-Access Memory (RAM), programmable read-only memory (PROM), electrically programmable read-only memory (EPROM), electrically erasable programmable read-only memory (EEPROM), magnetic disk or tape, and optically readable mediums including CD-ROM and DVD-ROM. Still further, the processes and logic described herein can be merged into one large process flow or divided into many sub-process flows. The order in which the process flows herein have been described is not critical and can be rearranged while still accomplishing the same results. Indeed, the process flows described herein may be rearranged, consolidated, and/or re-organized in their implementation as warranted or desired.

While the present invention has been illustrated by the description of embodiments thereof, and while the embodiments have been described in considerable detail, it is not the intention of the specification to restrict or in any way limit the scope of the appended claims to such detail. Additional advantages and modifications will readily appear to those skilled in the art. For example, the graphics displays of the present invention can include any type of graphical information or charts. Interactive links to additional information can include designations such as underlining, color-coding, and other attributes. Analytic engine reports can include suggestions and links to the execution of other analytic engines that may yield additional information. Vast amounts of reference materials can be linked to any generated suggested course of business action to increase the user's depth and understanding of the suggested action. Displays and reports can also be saved for future use or reference. The particular form and wording of the observations, warning, and suggested courses of business actions can be modified or changed. Therefore, the invention, in its broader aspects, is not limited to the specific details, the representative apparatus, and illustrative examples shown and described. Accordingly, departures may be made from such details without departing from the spirit or scope of the applicant's general inventive concept.

TABLE 1
Technology Trend Analysis for
Single Patent Assignee (PA)

| | Warning | Technology Trend Analytic Engine | Suggestion |
|---|---|---|---|
| Trend | ID | Warning Messages | ID(s) |
| Decreasing | T1A | As of DYEAR, PA has shown a DECREASING tend in patenting | ST1 |
| | | SUB-TECHNOLOGY Technology TECHNOLOGY. The rate of | |
| | | patenting has been decreasing at an average rate of DAVG patent | |
| | | documents per year. | |
| | | Is there an explanation for this DECREASING trend for PA ? | |
| Decreasing | T1B | In the most recent year, PA has ZERO (0) patent documents. | ST1 |
| (most recent | | | |
| year total = 0) | | | |
| Steady | T2A | As of STYEAR, PA has shown a STEADY tend in patenting SUB- | ST1 |
| | | TECHNOLOGY Technology TECHNOLOGY. The steady rate is | |
| | | STAVG patent documents per year. | |
| Steady | T2B | Over the last n years, PA has ZERO (0) patent documents. | ST1 |
| (Steady trend | | | |
| of 0 over (n) | | | |
| years) | | | |
| Increasing | T3A | As of IYEAR, PA has shown an INCREASING tend in patenting | ST1 |
| | | SUB-TECHNOLOGY Technology TECHNOLOGY. The rate of | |
| | | patenting has been increasing at an average rate of IAVG patent | |
| | | documents per year. | |
| | | Is there an explanation for PA's INCREASING trend in innovation? | |

TABLE 2
Technology Trend Analysis for
Multi-Assignee when Reference Patent Assignee (PA) has Decreasing Trend

| Other Patent | | | | | |
|---|---|---|---|---|---|
| Assignee(s) | | | | | |
| (PA + 1) . . . | | | Warning | Technology Trend Analytic Engine | Suggestion |
| Dec. | Steady | Inc. | ID | Warning Messages | ID |
| | | X | T4 | As of PA(DYEAR), PA has shown a DECREASING | ST1, ST2 |
| | | | | trend in patenting SUB-TECHNOLOGY Technology | |
| | | | | TECHNOLOGY, while PA + 1 has shown an | |
| | | | | INCREASING trend since PA + 1(IYEAR). | |
| | | | | During this trend period, PA's rate of patenting has been | |
| | | | | DECREASING at an average rate of PA(DAVG) patent | |
| | | | | documents per year, while PA + 1's rate of patenting has | |
| | | | | been INCREASING at an average rate of PA+1(IAVG) | |
| | | | | patent documents per year. | |
| | | | | Is there an explanation for PA's decreasing rate of | |
| | | | | innovation versus PA + 1's increasing rate ? | |
| | X | | T5 | As of PA(DYEAR), PA has shown a DECREASING | ST1, ST2 |
| | | | | trend in patenting SUB-TECHNOLOGY Technology | |
| | | | | TECHNOLOGY, while PA + 1 has shown a STEADY | |
| | | | | trend since PA + 1(STYEAR). | |
| | | | | During this trend period, PA's rate of patenting has been | |
| | | | | DECREASING at an average rate of PA(DAVG) patent | |
| | | | | documents per year, while PA + 1's rate of patenting has | |
| | | | | been holding STEADY. | |
| | | | | Is there an explanation for PA's decreasing rate of | |
| | | | | innovation versus PA + 1's steady rate ? | |
| X | | | T6 | As of PA(DYEAR), PA has shown a DECREASING | ST1, ST2 |
| | | | | trend in patenting SUB-TECHNOLOGY Technology | |
| | | | | TECHNOLOGY, while PA + 1 has shown a | |
| | | | | DECREASING trend since PA + 1(DYEAR). | |
| | | | | During this trend period, PA's rate of patenting has been | |
| | | | | DECREASING at an average rate of PA(DAVG) patent | |
| | | | | documents per year, while PA + 1's rate of patenting has | |
| | | | | been DECREASING at an average rate of | |
| | | | | PA + 1(DAVG). | |
| | | | | Is there an explanation for PA's decreasing rate of | |
| | | | | innovation versus PA + 1's decreasing rate ? | |

TABLE 3
Technology Trend Analysis for
Multi-Assignee when Reference Patent Assignee (PA) has Steady Trend

| Other Patent | | | | | |
|---|---|---|---|---|---|
| Assignee(s) | | | | | |
| (PA + 1) . . . | | | Warning | Technology Trend Analytic Engine | Suggestion |
| Dec. | Steady | Inc. | ID | Warning Messages | ID |
| | | X | T7 | As of PA(STYEAR), PA has shown a STEADY | ST1, ST2 |
| | | | | trend in patenting SUB-TECHNOLOGY | |
| | | | | Technology TECHNOLOGY, while PA + 1 has | |
| | | | | shown an INCREASING trend since | |
| | | | | PA + 1(STYEAR). | |
| | | | | During this trend period, PA has neither | |
| | | | | increased nor decreased its level of innovation, | |
| | | | | while PA + 1 has increased it's level of innovation | |
| | | | | at an average rate of PA + 1(IAVG) patent | |
| | | | | documents per year. | |
| | | | | Is there an explanation for PA's steady level of | |
| | | | | innovation versus PA + 1's increasing level ? | |
| X | | | T8 | As of PA(STYEAR), PA has shown a STEADY | ST1, ST2 |
| | | | | trend in patenting SUB-TECHNOLOGY | |
| | | | | Technology TECHNOLOGY, while PA + 1 has | |
| | | | | shown a DECREASING trend since | |
| | | | | PA + 1(DYEAR). | |
| | | | | During this trend period, PA has neither | |
| | | | | increased nor decreased its level of innovation, | |
| | | | | while PA + 1 has been decreasing its level of | |
| | | | | innovation at an average rate of PA + 1(DAVG) | |
| | | | | patent documents per year. | |
| | | | | Is there an explanation for PA's steady level of | |
| | | | | innovation versus PA + 1's decreasing level ? | |
| | X | | T9A | As of PA(STYEAR), PA has shown a STEADY | ST1, ST2 |
| | | | (PA + 1(STAVG) > | trend in patenting SUB-TECHNOLOGY | |
| | | | PA(STAVG) | Technology TECHNOLOGY, while PA + 1 has | |
| | | | | shown a STEADY trend since PA + 1(STYEAR). | |
| | | | | During this trend period, PA has maintained a | |
| | | | | steady trend of obtaining an average of | |
| | | | | PA(STAVG) patent documents per year, while | |
| | | | | PA + 1 has maintained a steady trend of obtaining | |
| | | | | an average PA + 1(STAVG) patent documents per | |
| | | | | year. | |
| | | | | Is there an explanation for PA's steady average | |
| | | | | being less than PA + 1's steady average ? | |
| | X | | T9B | As of PA(STYEAR), PA has shown a STEADY | ST1, ST2 |
| | | | (PA + 1(STAVG) < | trend in patenting SUB-TECHNOLOGY | |
| | | | PA(STAVG) | Technology TECHNOLOGY, while PA + 1 has | |
| | | | | shown a STEADY trend since PA + 1(STYEAR). | |
| | | | | During this trend period, PA has maintained a | |
| | | | | steady trend of obtaining an average of | |
| | | | | PA(STAVG) patent documents per year, while | |
| | | | | PA + 1 has maintained a steady trend of obtaining | |
| | | | | an average PA + 1(STAVG) patent documents per | |
| | | | | year. | |
| | | | | Is there an explanation for PA's steady average | |
| | | | | being greater than PA + 1's steady average ? | |

TABLE 4
Technology Trend Analysis for
Multi-Assignee when Reference Patent Assignee (PA) has Increasing Trend

| Other Patent | | | | | |
|---|---|---|---|---|---|
| Assignee(s) | | | | | |
| (PA + 1) . . . | | | Warning | Technology Trend Analytic Engine | Suggestion |
| Dec. | Steady | Inc. | ID | Warning Messages | ID |
| | | X | T10A | As of PA(IYEAR), PA has shown an | ST1, ST2 |
| | | | (PA + 1(IAVG) > | INCREASING trend in patenting SUB- | |
| | | | PA(IAVG)) | TECHNOLOGY Technology TECHNOLOGY, | |
| | | | | while PA + 1 has shown an INCREASING trend | |
| | | | | since PA + 1(IYEAR). | |
| | | | | During this trend period, PA's average rate of | |
| | | | | increase per year is PA(IAVG), while PA + 1 has | |
| | | | | an average rate of increase per year of | |
| | | | | PA + 1(IAVG). | |
| | | | | Is there an explanation for PA's increasing rate of | |
| | | | | innovation being less than PA + 1's increasing rate ? | |
| | | X | T10B | As of PA(IYEAR), PA has shown an | ST1, ST2 |
| | | | (PA + 1(IAVG) < | INCREASING trend in patenting SUB- | |
| | | | PA(IAVG)) | TECHNOLOGY Technology TECHNOLOGY, | |
| | | | | while PA + 1 has shown an INCREASING trend | |
| | | | | since PA + 1(IYEAR). | |
| | | | | During this trend period, PA's average rate of | |
| | | | | increase per year is PA(IAVG), while PA + 1 has | |
| | | | | an average rate of increase per year of | |
| | | | | PA + 1(IAVG). | |
| | | | | Is there an explanation for PA's increasing rate of | |
| | | | | innovation being greater than PA + 1's increasing | |
| | | | | rate ? | |
| | X | | T11 | As of PA(IYEAR), PA has shown an | ST1, ST2 |
| | | | | INCREASING trend in patenting SUB- | |
| | | | | TECHNOLOGY Technology TECHNOLOGY, | |
| | | | | while PA + 1 has shown a STEADY trend since | |
| | | | | PA + 1(STYEAR). | |
| | | | | During this trend period, PA's average rate of | |
| | | | | increase per year is PA(IAVG) patent | |
| | | | | documents, while PA + 1 has neither increased | |
| | | | | nor decreased it's level of innovation since | |
| | | | | PA + 1(STYEAR). | |
| | | | | Is there an explanation for PA's increasing rate of | |
| | | | | innovation versus PA + 1's unchanged level of | |
| | | | | innovation ? | |
| X | | | T12 | As of PA(IYEAR), PA has shown an | ST1, ST2 |
| | | | | INCREASING trend in patenting SUB- | |
| | | | | TECHNOLOGY Technology TECHNOLOGY, | |
| | | | | while PA + 1 has shown a DECREASING trend | |
| | | | | since PA + 1(IYEAR). | |
| | | | | During this trend period, PA's average rate of | |
| | | | | increase per year is PA(IAVG) patent | |
| | | | | documents, while PA + 1 has decreased it's level | |
| | | | | of innovation at an average rate of | |
| | | | | PA + 1(DAVG) patent documents per year. | |
| | | | | Is there an explanation for PA's increasing rate of | |
| | | | | innovation versus PA + 1's decreasing rate of | |
| | | | | innovation ? | |

TABLE 5
Technology Trend Analysis Suggestions for
Reference Patent Assignee (PA) and Other Patent Assignee(s) (PA + 1) . . .

| Suggestion | |
|---|---|
| ID | Technology Trend Analysis Suggestion Message |
| ST1 | Review Industry Forecasts for trend information regarding increased or decreased future demand |
| | for SUB-TECHNOLOGY technology TECHNOLOGY: |
| | If Industry Forecasts indicate increased future demand for SUB-TECHNOLOGY |
| | technology TECHNOLOGY then review your PA's business plan for a clear business objective that |
| | requires an increase in SUB-TECHNOLOGY innovation. |
| | More on increasing Innovation and Patent holdings. |
| | If Industry Forecasts indicate decreased future demand for SUB-TECHNOLOGY |
| | technology TECHNOLOGY then review your PA's business plan to ensure that any clear business |
| | objectives do not require a modification in the level of innovation. |
| ST2 | Assess present patent holdings for scope of claim coverage and remaining patent term and augment |
| | PA's present business objectives, as necessary. |
| | More on assessing patent holdings. |
| . . . | . . . |

TABLE 6
Marketing Analysis for
Single Patent Assignee (PA)

| | Warning | Marketing Analytic Engine | Suggestion |
|---|---|---|---|
| Trend | ID | Warning Messages | ID(s) |
| Decreasing | M1A | As of DYEAR, PA has shown a DECREASING tend in patenting | SM1, SM2 |
| | | this technology. The rate of patenting has been decreasing at an | |
| | | average rate of DAVG patent documents per year. | |
| | | Given this decreasing trend, there is a danger that PA is losing its | |
| | | ability to market itself and/or its products as a leader in this | |
| | | technology over its competitors. | |
| Decreasing | M1B | In the most recent year, PA has ZERO (0) patent documents. | SM1, SM2 |
| (most recent | | | |
| year total = 0) | | | |
| Steady | M2A | As of STYEAR, PA has shown a STEADY tend in patenting this | SM1 |
| | | technology. The rate of patenting has been holding steady at an | |
| | | average rate of STAVG patent documents per year. | |
| | | Given this steady trend, there is a danger that PA is losing its ability | |
| | | to market itself and/or its products as an innovative leader in this | |
| | | technology over its competitors. | |
| Steady | M2B | Over the last n years, PA has ZERO (0) patent documents. | SM1 |
| (Steady trend | | | |
| of 0 over (n) | | | |
| years) | | | |
| Increasing | M3 | As of IYEAR, PA has shown an INCREASING tend in patenting | SM1, SM2 |
| | | this technology. The rate of patenting has been increasing at an | |
| | | average rate of IAVG patent documents per year. | |
| | | While this increasing trend is a positive attribute, PA's competitors | |
| | | may be also be patenting with an increasing tend and with an | |
| | | average rate of increase that is greater than PA's, which may | |
| | | endanger PA's ability to market itself and/or its products as an | |
| | | innovative leader in this technology. | |

TABLE 7
Marketing Analysis for
Multi-Assignee when Reference Patent Assignee (PA) has Decreasing Trend

| Other Patent | | | | | |
|---|---|---|---|---|---|
| Assignee(s) | | | | | |
| (PA + 1) . . . | | | Warning | Marketing Analytic Engine | Suggestion |
| Dec. | Steady | Inc. | ID | Warning Messages | ID |
| | | X | M4 | As of PA(DYEAR), PA has shown a DECREASING | SM3, SM4, |
| | | | | trend in patenting this technology, while PA + 1 has | SM5 |
| | | | | shown an INCREASING trend since PA + 1(IYEAR). | |
| | | | | During this trend period, PA's rate of patenting has been | |
| | | | | DECREASING at an average rate of PA(DAVG) patent | |
| | | | | documents per year, while PA + 1's rate of patenting has | |
| | | | | been INCREASING at an average rate of PA + 1(IAVG) | |
| | | | | patent documents per year | |
| | | | | PA + 1 may try to market itself as an innovative leader in | |
| | | | | this technology by relying on its recent increasing trend | |
| | | | | in patenting since PA + 1(IYEAR). | |
| | X | | M5 | As of PA(DYEAR), PA has shown a DECREASING | SM3, SM4, |
| | | | | trend in patenting this technology, while PA + 1 has | SM5 |
| | | | | shown a STEADY trend since PA + 1(STYEAR). | |
| | | | | During this trend period, PA's rate of patenting has been | |
| | | | | DECREASING at an average rate of PA(DAVG) patent | |
| | | | | documents per year, while PA + 1's rate of patenting has | |
| | | | | been holding STEADY. | |
| | | | | PA + 1 may try to market itself as an innovative leader in | |
| | | | | this technology because of its recent steady trend in | |
| | | | | innovation and patenting since PA + 1(STYEAR) | |
| X | | | M6 | As of PA(DYEAR), PA has shown a DECREASING | SM3, SM4, |
| | | | | trend in patenting this technology, while PA + 1 has | SM5 |
| | | | | shown a DECREASING trend since PA + 1(DYEAR). | |
| | | | | During this trend period, PA's rate of patenting has been | |
| | | | | DECREASING at an average rate of PA(DAVG) patent | |
| | | | | documents per year, while PA + 1's rate of patenting has | |
| | | | | been DECREASING at an average rate of | |
| | | | | PA + 1(DAVG). | |
| | | | | Though PA + 1 has a decreasing trend in patenting this | |
| | | | | technology, PA + 1 may still try to market itself as an | |
| | | | | innovative leader in this technology. | |

TABLE 8
Marketing Analysis for
Multi-Assignee when Reference Patent Assignee (PA) has Steady Trend

| Other Patent | | | | | |
|---|---|---|---|---|---|
| Assignee(s) | | | | | |
| (PA + 1) . . . | | | Warning | Marketing Analytic Engine | Suggestion |
| Dec. | Steady | Inc. | ID | Warning Messages | ID |
| | | X | M7 | As of PA(STYEAR), PA has shown a STEADY | SM3, SM4, |
| | | | | trend in patenting this technology, while PA + 1 | SM5 |
| | | | | has shown an INCREASING trend since | |
| | | | | PA + 1(STYEAR). | |
| | | | | During this trend period, PA has neither | |
| | | | | increased nor decreased its level of innovation, | |
| | | | | while PA + 1 has increased it's level of innovation | |
| | | | | at an average rate of PA + 1(IAVG) patent | |
| | | | | documents per year. | |
| | | | | PA + 1 may try to market itself as an innovative | |
| | | | | leader in this technology because of its recent | |
| | | | | increasing trend in patent documents it received | |
| | | | | since PA + 1(IYEAR). | |
| X | | | M8 | As of PA(STYEAR), PA has shown a STEADY | SM3, SM4, |
| | | | | trend in patenting this technology, while PA + 1 | SM5, SM6 |
| | | | | has shown a DECREASING trend since | |
| | | | | PA + 1(DYEAR). | |
| | | | | During this trend period, PA has neither | |
| | | | | increased nor decreased its level of innovation, | |
| | | | | while PA + 1 has been decreasing its level of | |
| | | | | innovation at an average rate of PA + 1(DAVG) | |
| | | | | patent documents per year. | |
| | | | | Though PA + 1 has a decreasing trend in | |
| | | | | patenting this technology, PA + 1 may still try to | |
| | | | | market itself as an innovative leader in this | |
| | | | | technology. | |
| | X | | M9A | As of PA(STYEAR), PA has shown a STEADY | SM3, SM4, |
| | | | (PA + 1(STAVG) > | trend in patenting this technology, while PA + 1 | SM5 |
| | | | PA(STAVG) | has shown a STEADY trend since | |
| | | | | PA + 1(STYEAR). | |
| | | | | During this trend period, PA has maintained a | |
| | | | | steady trend of obtaining an average of | |
| | | | | PA(STAVG) patent documents per year, while | |
| | | | | PA + 1 has maintained a steady trend of obtaining | |
| | | | | an average PA + 1(STAVG) patent documents per | |
| | | | | year. | |
| | | | | PA + 1 may try to market itself as an innovative | |
| | | | | leader in this technology by relying on its recent | |
| | | | | steady trend in innovation and patenting since | |
| | | | | PA + 1(IYEAR). | |
| | X | | M9B | As of PA(STYEAR), PA has shown a STEADY | SM3, SM4, |
| | | | (PA + 1(STAVG) < | trend in patenting this technology, while PA + 1 | SM5 |
| | | | PA(STAVG) | has shown a STEADY trend since | |
| | | | | PA + 1(STYEAR). | |
| | | | | During this trend period, PA has maintained a | |
| | | | | steady trend of obtaining an average of | |
| | | | | PA(STAVG) patent documents per year, while | |
| | | | | PA + 1 has maintained a steady trend of obtaining | |
| | | | | an average PA + 1(STAVG) patent documents per | |
| | | | | year. | |
| | | | | PA + 1 may try to market itself as an innovative | |
| | | | | leader in this technology by relying its recent | |
| | | | | steady trend in innovation and patenting since | |
| | | | | PA + 1(IYEAR). | |

TABLE 9
Marketing Analysis for
Multi-Assignee when Reference Patent Assignee (PA) has Increasing Trend

| Other Patent | | | | | |
|---|---|---|---|---|---|
| Assignee(s) | | | | | |
| (PA + 1) . . . | | | Warning | Marketing Analytic Engine | Suggestion |
| Dec. | Steady | Inc. | ID | Warning Messages | ID |
| | | X | M10A | As of PA(IYEAR), PA has shown an | SM3, SM4, |
| | | | (PA + 1(IAVG) > | INCREASING trend in patenting this | SM5 |
| | | | PA(IAVG)) | technology, while PA + 1 has shown an | |
| | | | | INCREASING trend since PA + 1(IYEAR). | |
| | | | | During this trend period, PA's average rate of | |
| | | | | increase per year is PA(IAVG), while PA + 1 has | |
| | | | | an average rate of increase per year of | |
| | | | | PA + 1(IAVG). | |
| | | | | PA + 1 may try to market itself as an innovative | |
| | | | | leader in this technology by relying on its recent | |
| | | | | increasing trend in innovation and patenting | |
| | | | | since PA + 1(IYEAR). | |
| | | X | M10B | As of PA(IYEAR), PA has shown an | SM3, SM4, |
| | | | (PA + 1(IAVG) < | INCREASING trend in patenting this | SM5 |
| | | | PA(IAVG)) | technology, while PA + 1 has shown an | |
| | | | | INCREASING trend since PA + 1(IYEAR). | |
| | | | | During this trend period, PA's average rate of | |
| | | | | increase per year is PA(IAVG), while PA + 1 has | |
| | | | | an average rate of increase per year of | |
| | | | | PA + 1(IAVG). | |
| | | | | PA + 1 may try to market itself as an innovative | |
| | | | | leader in this technology by relying on its recent | |
| | | | | increasing trend in innovation and patenting | |
| | | | | since PA + 1(IYEAR). | |
| | X | | M11 | As of PA(IYEAR), PA has shown an | SM3, SM4, |
| | | | | INCREASING trend in patenting this | SM5 |
| | | | | technology, while PA + 1 has shown a STEADY | |
| | | | | trend since PA + 1(STYEAR). | |
| | | | | During this trend period, PA's average rate of | |
| | | | | increase per year is PA(IAVG) patent | |
| | | | | documents, while PA + 1 has neither increased | |
| | | | | nor decreased it's level of innovation since | |
| | | | | PA + 1(STYEAR). | |
| | | | | PA + 1 may try to market itself as an innovative | |
| | | | | leader in this technology because of its recent | |
| | | | | steady trend in innovation and patenting since | |
| | | | | PA + 1(STYEAR). | |
| X | | | M12 | As of PA(IYEAR), PA has shown an | SM3, SM4, |
| | | | | INCREASING trend in patenting SUB- | SM5 |
| | | | | TECHNOLOGY Technology TECHNOLOGY, | |
| | | | | while PA + 1 has shown a DECREASING trend | |
| | | | | since PA + 1(IYEAR). | |
| | | | | During this trend period, PA's average rate of | |
| | | | | increase per year is PA(IAVG) patent | |
| | | | | documents, while PA + 1 has decreased it's level | |
| | | | | of innovation at an average rate of | |
| | | | | PA + 1(DAVG) patent documents per year. | |
| | | | | Though PA + 1 has a decreasing trend in | |
| | | | | patenting this technology, PA + 1 may still try to | |
| | | | | market itself as an innovative leader in this | |
| | | | | technology. | |

TABLE 10
Marketing Analysis Suggestions for
Reference Patent Assignee (PA) and Other Patent Assignee(s) (PA + 1) . . .

| Suggestion | |
|---|---|
| ID | Marketing Analysis Suggestion Message |
| SM1 | Run a Marketing Analysis Report to evaluate PA's marketing position in this technology versus one |
| | or more competitors. (Show me how). |
| SM2 | Evaluate PA's business plan to determine if this technology is being replaced with a new |
| | technology and consider marketing the new technology over the presently fading technology. |
| SM3 | (SM3 is generated if PA's total number of patent documents for this technology is greater than |
| | PA + 1's total number for the same technology): |
| | PA should evaluate using their total number of patent documents in this technology as a marketing |
| | strength over PA + 1's lesser number of patent documents, including: |
| | PA can market itself as the innovative leader in this type of technology development over the |
| | last [years spanning analysis] years. |
| | PA can market itself as receiving, on average, more patent documents per year in this |
| | technology than its competitors (i.e., PA + 1). |
| SM4 | (SM4 is generated if based on a comparison of a summation of year-by-year patent document totals, |
| | PA go back some number of years (e.g., X years) where PA can say its total number of patent |
| | documents during that X year period is greater than PA + 1 total number): |
| | PA can justifiably market itself as an innovative leader by having received more patent documents |
| | in this technology over the last X years than its major competitor (i.e., PA + 1): |
| | PA can also justifiably market itself as an innovative leader in this technology by receiving, |
| | on average, more patent documents per year over the last X years than others in this |
| | technology. |
| SM5 | PA should assess its present patent holdings for scope of claim coverage for any patented |
| | technology that can be considered “pioneering.” If such a “pioneering” technology can be found, |
| | PA can justifiably market itself as having developed and pioneered that particular technology. |
| | More on assessing patent holdings |
| SM6 | PA should market itself as having maintained constant level of innovation in patenting this |
| | technology since PA(STYEAR), while others have decreased their level of innovation (i.e., PA + 1). |
| . . . | . . . |

TABLE 11
Research and Development Analysis for
Single Patent Assignee (PA)

| | Warning | Research and Development Analytic Engine | Suggestion |
|---|---|---|---|
| Trend | ID | Warning Messages | ID(s) |
| Decreasing | R1A | As of DYEAR, PA has shown a DECREASING tend in patenting | SR1 |
| | | this technology. The rate of patenting has been decreasing at an | |
| | | average rate of DAVG patent documents per year. | |
| | | Given this decreasing trend, there is a danger that PA is losing its | |
| | | innovative edge against its competitors for this technology. | |
| Decreasing | R1B | In the most recent year, PA has ZERO (0) patent documents. | SR1, SR2 |
| (most recent | | | |
| year total = 0) | | | |
| Steady | R2A | As of STYEAR, PA has shown a STEADY tend in patenting this | SR1 |
| | | technology. The rate of patenting has been holding steady at an | |
| | | average rate of STAVG patent documents per year. | |
| | | Given this steady trend, there is a danger that PA is losing its | |
| | | innovative edge against its competitors for this technology. | |
| Steady | R2B | Over the last n years, PA has ZERO (0) patent documents. | SR1 |
| (Steady trend | | | |
| of 0 over (n) | | | |
| years) | | | |
| Increasing | R3A | As of IYEAR, PA has shown an INCREASING tend in patenting | SR1, SR2 |
| | | this technology. The rate of patenting has been increasing at an | |
| | | average rate of IAVG patent documents per year. | |
| | | While this increasing trend is a positive attribute, PA's competitors | |
| | | may be also be patenting with an increasing tend and with an | |
| | | average rate of increase that is greater than PA's, which may | |
| | | endanger PA's innovative edge in this technology. | |

TABLE 12
Research and Development Analysis for
Multi-Assignee when Reference Patent Assignee (PA) has Decreasing Trend

| Other Patent | | | | | |
|---|---|---|---|---|---|
| Assignee(s) | | | | | |
| (PA + 1) . . . | | | Warning | Marketing Analytic Engine | Suggestion |
| Dec. | Steady | Inc. | ID | Warning Messages | ID |
| | | X | R4 | As of PA(DYEAR), PA has shown a DECREASING | SR3, SR4, |
| | | | | trend in patenting this technology, while PA + 1 has | SR5 |
| | | | | shown an INCREASING trend since PA + 1(IYEAR). | |
| | | | | During this trend period, PA's rate of patenting has been | |
| | | | | DECREASING at an average rate of PA(DAVG) patent | |
| | | | | documents per year, while PA + 1's rate of patenting has | |
| | | | | been INCREASING at an average rate of PA + 1(IAVG) | |
| | | | | patent documents per year. | |
| | | | | Based on this analysis, PA + 1's research and | |
| | | | | development efforts have provided PA + 1 with an | |
| | | | | innovative edge in this technology since | |
| | | | | PA + 1(IYEAR). | |
| | X | | R5 | As of PA(DYEAR), PA has shown a DECREASING | SR3, SR4, |
| | | | | trend in patenting this technology, while PA + 1 has | SR5 |
| | | | | shown a STEADY trend since PA + 1(STYEAR). | |
| | | | | During this trend period, PA's rate of patenting has been | |
| | | | | DECREASING at an average rate of PA(DAVG) patent | |
| | | | | documents per year, while PA + 1's rate of patenting has | |
| | | | | been holding STEADY. | |
| | | | | Based on this analysis, PA + 1's research and | |
| | | | | development efforts may have provided PA + 1 with an | |
| | | | | innovative edge in this technology since | |
| | | | | PA + 1(STYEAR). | |
| X | | | R6 | As of PA(DYEAR), PA has shown a DECREASING | SR3, SR4, |
| | | | | trend in patenting this technology, while PA + 1 has | SR5 |
| | | | | shown a DECREASING trend since PA + 1(DYEAR). | |
| | | | | During this trend period, PA's rate of patenting has been | |
| | | | | DECREASING at an average rate of PA(DAVG) patent | |
| | | | | documents per year, while PA + 1's rate of patenting has | |
| | | | | been DECREASING at an average rate of | |
| | | | | PA + 1(DAVG). | |
| | | | | Though PA + 1 has a decreasing trend in patenting this | |
| | | | | technology, PA + 1 may still have an innovative edge in | |
| | | | | this technology. | |

TABLE 13
Research and Development Analysis for
Multi-Assignee when Reference Patent Assignee (PA) has Steady Trend

| Other Patent | | | | | |
|---|---|---|---|---|---|
| Assignee(s) | | | | | |
| (PA + 1) . . . | | | Warning | Marketing Analytic Engine | Suggestion |
| Dec. | Steady | Inc. | ID | Warning Messages | ID |
| | | X | R7 | As of PA(STYEAR), PA has shown a STEADY | SR3, SR4, |
| | | | | trend in patenting this technology, while PA + 1 | SR5 |
| | | | | has shown an INCREASING trend since | |
| | | | | PA + 1(IYEAR). | |
| | | | | During this trend period, PA has neither | |
| | | | | increased nor decreased its level of innovation, | |
| | | | | while PA + 1 has increased it's level of innovation | |
| | | | | at an average rate of PA + 1(IAVG) patent | |
| | | | | documents per year. | |
| | | | | Based on this analysis, PA + 1's research and | |
| | | | | development efforts may have provided PA + 1 | |
| | | | | with an innovative edge in this technology since | |
| | | | | PA + 1(IYEAR). | |
| X | | | R8 | As of PA(STYEAR), PA has shown a STEADY | SR3, SR4, |
| | | | | trend in patenting this technology, while PA + 1 | SR5, SR6 |
| | | | | has shown a DECREASING trend since | |
| | | | | PA + 1(DYEAR). | |
| | | | | During this trend period, PA has neither | |
| | | | | increased nor decreased its level of innovation, | |
| | | | | while PA + 1 has been decreasing its level of | |
| | | | | innovation at an average rate of PA + 1(DAVG) | |
| | | | | patent documents per year. | |
| | | | | Though PA + 1 has a decreasing trend in | |
| | | | | patenting this technology, PA + 1 may still have | |
| | | | | an innovative edge in this technology. | |
| | X | | R9A | As of PA(STYEAR), PA has shown a STEADY | SR3, SR5, |
| | | | (PA + 1(STAVG) > | trend in patenting this technology, while PA + 1 | SR5 |
| | | | PA(STAVG) | has shown a STEADY trend since | |
| | | | | PA + 1(STYEAR). | |
| | | | | During this trend period, PA has maintained a | |
| | | | | steady trend of obtaining an average of | |
| | | | | PA(STAVG) patent documents per year, while | |
| | | | | PA + 1 has maintained a steady trend of obtaining | |
| | | | | an average PA + 1(STAVG) patent documents per | |
| | | | | year. | |
| | | | | Based on this analysis, PA + 1's research and | |
| | | | | development efforts may have provided PA + 1 | |
| | | | | with an innovative edge in this technology since | |
| | | | | PA + 1(IYEAR). | |
| | X | | R9B | As of PA(STYEAR), PA has shown a STEADY | SR3, SR4, |
| | | | (PA + 1(STAVG) < | trend in patenting this technology, while PA + 1 | SR5 |
| | | | PA(STAVG) | has shown a STEADY trend since | |
| | | | | PA + (STYEAR). | |
| | | | | During this trend period, PA has maintained a | |
| | | | | steady trend of obtaining an average of | |
| | | | | PA(STAVG) patent documents per year, while | |
| | | | | PA + 1 has maintained a steady trend of obtaining | |
| | | | | an average PA + 1(STAVG) patent documents per | |
| | | | | year. | |
| | | | | Based on this analysis, PA + 1's research and | |
| | | | | development efforts may have provided PA + 1 | |
| | | | | with an innovative edge in this technology since | |
| | | | | PA + 1(STYEAR). | |
| | X | | R9C | Since PA(STYEAR), PA has not obtained any | SR2, |
| | | | (PA + 1(STAVG) = | patents. Also, since PA + 1(STYEAR), PA + 1 has | SR3, SR4, |
| | | | PA(STAVG) = 0) | not obtained any patents. | SR5 |
| | X | | R9D | As of PA(STYEAR), PA has shown a STEADY | SR2, |
| | | | (PA + 1(STAVG) = | trend in patenting this technology, while PA + 1 | SR3, SR4, |
| | | | PA(STAVG)) | has shown a STEADY trend since | SR5 |
| | | | | PA + 1(STYEAR). | |
| | | | | During this trend period, both PA and PA + 1 | |
| | | | | have maintained a steady trend of obtaining an | |
| | | | | average of PA(STAVG) patent documents per | |
| | | | | year | |

TABLE 14
Research and Development Analysis for
Multi-Assignee when Reference Patent Assignee (PA) has Increasing Trend

| Other Patent | | | | | |
|---|---|---|---|---|---|
| Assignee(s) | | | | | |
| (PA + 1) . . . | | | Warning | Marketing Analytic Engine | Suggestion |
| Dec. | Steady | Inc. | ID | Warning Messages | ID |
| | | X | R10A | As of PA(IYEAR), PA has shown an | SR3, SR4, |
| | | | (PA + 1(IAVG) > | INCREASING trend in patenting this | SR5 |
| | | | PA(IAVG)) | technology, while PA + 1 has shown an | |
| | | | | INCREASING trend since PA + 1(IYEAR). | |
| | | | | During this trend period, PA's average rate of | |
| | | | | increase per year is PA(IAVG), while PA + 1 has | |
| | | | | an average rate of increase per year of | |
| | | | | PA + 1(IAVG). | |
| | | | | Based on this analysis, PA + 1's research and | |
| | | | | development efforts may have provided PA + 1 | |
| | | | | with an innovative edge in this technology since | |
| | | | | PA + 1(IYEAR). | |
| | | X | R10B | As of PA(IYEAR), PA has shown an | SR3, SR4, |
| | | | (PA + 1(IAVG) < | INCREASING trend in patenting this | SR5 |
| | | | PA(IAVG)) | technology, while PA + 1 has shown an | |
| | | | | INCREASING trend since PA + 1(IYEAR). | |
| | | | | During this trend period, PA's average rate of | |
| | | | | increase per year is PA(IAVG), while PA + 1 has | |
| | | | | an average rate of increase per year of | |
| | | | | PA + 1(IAVG). | |
| | | | | Based on this analysis, PA + 1's research and | |
| | | | | development efforts may have provided PA + 1 | |
| | | | | with an innovative edge in this technology since | |
| | | | | PA + 1(IYEAR). | |
| | | X | R10C | As of PA(IYEAR), PA has shown an | SR3, SR4, |
| | | | (PA + 1(IAVG) = | INCREASING trend in patenting this | SR5 |
| | | | PA(IAVG)) | technology, while PA + 1 has shown an | |
| | | | | INCREASING trend since PA + 1(IYEAR). | |
| | | | | During this trend period, both PA and PA + 1 | |
| | | | | have an average rate of increase per year of | |
| | | | | PA(IAVG). | |
| | | | | Based on this analysis, PA + 1's research and | |
| | | | | development efforts may have provided PA + 1 | |
| | | | | with an innovative edge in this technology since | |
| | | | | PA + 1(IYEAR). | |
| | X | | R11 | As of PA(IYEAR), PA has shown an | SR3, SR4, |
| | | | | INCREASING trend in patenting this | SR5 |
| | | | | technology, while PA + 1 has shown a STEADY | |
| | | | | trend since PA + 1(STYEAR). | |
| | | | | During this trend period, PA's average rate of | |
| | | | | increase per year is PA(IAVG) patent | |
| | | | | documents, while PA + 1 has neither increased | |
| | | | | nor decreased it's level of innovation since | |
| | | | | PA + 1(STYEAR). | |
| | | | | Based on this analysis, PA + 1's research and | |
| | | | | development efforts may have provided PA + 1 | |
| | | | | with an innovative edge in this technology since | |
| | | | | PA + 1(STYEAR). | |
| X | | | R12 | As of PA(IYEAR), PA has shown an | SR3, SR4, |
| | | | | INCREASING trend in patenting SUB- | SR5, SR6 |
| | | | | TECHNOLOGY Technology TECHNOLOGY, | |
| | | | | while PA + 1 has shown a DECREASING trend | |
| | | | | since PA + 1(IYEAR). | |
| | | | | During this trend period, PA's average rate of | |
| | | | | increase per year is PA(IAVG) patent | |
| | | | | documents, while PA + 1 has decreased it's level | |
| | | | | of innovation at an average rate of | |
| | | | | PA + 1(DAVG) patent documents per year. | |
| | | | | Based on this analysis, PA + 1's research and | |
| | | | | development efforts may have provided PA + 1 | |
| | | | | with an innovative edge in this technology since | |
| | | | | PA + 1(STYEAR). | |

TABLE 15
Research and Development Analysis Suggestions for
Reference Patent Assignee (PA) and Other Patent Assignee(s) (PA + 1) . . .

| Suggestion | |
|---|---|
| ID | Research and Development Analysis Suggestion Message |
| SR1 | Run an Invengine ™ Research and Development Analysis Report to evaluate PA's research and |
| | development efforts in this technology versus one or more competitors. (Show me how). |
| SR2 | Evaluate PA's business plan to determine if this technology is being replaced with a new |
| | technology and consider increasing research and development efforts in the new technology over |
| | the presently fading technology. |
| SR3 | PA should review its research and development efforts for this technology: |
| | If this technology falls WITHIN a clear business objective of PA, then PA should increase its |
| | research and development efforts for this technology. |
| | If this technology DOES NOT fall within a clear business objective of PA, then PA can |
| | consider reducing or eliminating its research and development efforts for this technology. |
| SR4 | If PA is UNDECIDED as to a clear business objective in this technology, it is highly recommended |
| | that a Core Technology, Technology Trend, and/or Marketing Report be executed as an aid in the |
| | decision making process. |
| SR5 | PA should assess its present patent holdings for scope of claim coverage for any patented |
| | technology that can be considered “pioneering.” If such a “pioneering” technology can be found, |
| | PA should increase its level of research and development by improving around the “pioneering” |
| | technology. |
| | More on assessing patent holdings. |
| SR6 | PA should review PA + 1's patent document portfolio for this technology to determine if PA + 1 has |
| | patented a “pioneering” technology, which has allowed PA + 1's research and development resources |
| | to be directed to other technologies. |
| | Identify possible technologies to which PA + 1 may have shifted its research and development efforts |
| | by executing a Research and Development Re-Allocation Sub-Analytic Engine for PA + 1). |
| . . . | . . . |

TABLE 16
Core Technology Analysis for
Reference Patent Assignee (PA)

| Core | Warning | Core Technology Analytic Engine Warning | Suggestion |
|---|---|---|---|
| Technology Condition | ID | Messages | ID |
| For Each Core | [No Warning] | [No Warning Message] | SC1, SC2 |
| Technology Type | | | |
| For Non-Core | C1 | PA does not have a Core Technology in the | SC6 |
| Technology Types | | following areas: | |
| | | [List non-Core Technology | |
| | | TECHNOLOGY(IES)] | |

TABLE 17
Core Technology Analysis for
Reference Patent Assignee (PA) and Other Patent Assignee(s) (PA + 1) . . .

| Core | Warning | Core Technology Analytic Engine Warning | Suggestion |
|---|---|---|---|
| Technology Condition | ID | Messages | ID |
| PA is missing a Core | C2 | PA has NO Core Technology in | SC3 |
| Technology Type found | | TECHNOLOGY, compared to PA + 1 | |
| in Other Patent | | | |
| Assignee(s) | | | |
| PA + 1 has more Patent | C3 | PA + 1 has more patents in the following Core | SC4 |
| Documents in a Core | | Technology Types: | |
| Technology Type than | | [List Core Technology Types . . . ] | |
| PA | | | |
| PA has more Patent | C4 | PA has more patent in the following Core | SC5 |
| Documents in a Core | | Technology Types: | |
| Technology Type than | | [List Core Technology Types . . . ] | |
| PA + 1 | | | |

TABLE 18
Core Technology Analysis Suggestions for
Reference Patent Assignee (PA) and Other Patent Assignee(s) (PA + 1) . . .

| Suggestion | |
|---|---|
| ID | Research and Development Analysis Suggestion Message |
| SC1 | Review Industry forecasts for trend information resulting in increased or decreased future demand |
| | for your company's core technologies-and, if necessary, adjust your company's core technology |
| | distribution to meet any clear business objectives. |
| SC2 | Review your Company's business plan: |
| | Does the above core technology distribution adequately position your company in accord with your |
| | company's future strategic business planning or clear future business objectives ? |
| | (a) If not, determine what core technology needs to be added or what changes need to be |
| | implemented to your company's core technology distribution. |
| | (b) If yes, ensure that your company's future business plan and clear business objectives |
| | adequately support maintaining the present core technology distribution. |
| SC3 | Review Industry forecasts and your Company's business plan for a clear business objective that |
| | requires the development of a core technological competency in TECHNOLOGY technology. |
| SC4 | Under each of PA + 1's Technology types, review the sub-technology types for strengths and |
| | weaknesses in core sub-technologies. Analyze these strengths and weaknesses against any clear |
| | business objectives of your Company. |
| SC5 | Under each of your Company's Technology types, review the sub-technology types for strengths |
| | and weaknesses in core sub-technologies. Analyze these strengths and weaknesses against any |
| | clear business objectives of your Company. |
| SC6 | Review Industry forecasts for trend information resulting in increased or decreased future demand |
| | for your company's non-core technologies-and, if necessary, adjust your company's core |
| | technology distribution to meet any clear business objectives. |
| . . . | . . . |

I claim:

1. A method of analyzing patent-related data comprising:
reading patent-related data;
identifying at least a first trend associated with the read patent-related data;
generating at least one warning based on the identified at least first trend; and
generating at least one suggested action based on the identified at least first trend.

2. The method of claim 1 wherein the step of identifying at least a first trend further comprises identifying at least a second trend associated with the patent-related data.

3. The method of claim 2 wherein the step of generating at least one warning based on the identified at least first trend comprises generating at least one warning based on the identified first and second trends.

4. The method of claim 2 wherein the step of generating at least one suggested action based on the identified at least first trend comprises generating at least one suggestion based on the identified first and second trends.

5. The method of claim 1 wherein the step of identifying at least a first trend associated with the patent-related data comprises identifying the most recent chronological trend associated with the patent-related data.

6. The method of claim 1 wherein the step of identifying at least a first trend comprises identifying a trend selected from the group consisting of: increasing, decreasing and steady trends.

7. The method of claim 1 wherein the step of identifying at least a first trend associated with the patent-related document information comprises identifying a plurality of trends associated with patent-related data.

8. The method of claim 1 wherein the step of generating at least one warning comprises the step of generating at least one warning associated with a marketing ability of at least one patent assignee.

9. The method of claim 1 wherein the step of generating at least one suggested action comprises the step of generating at least one suggested action associated with a marketing position of at least one patent assignee.

10. The method of claim 1 wherein the step of generating at least one warning comprises the step of generating at least one warning associated with at least one technology trend of at least one patent assignee.

11. The method of claim 1 wherein the step of generating at least one suggested action comprises the step of generating at least one suggested action associated with at least one technology trend of at least one patent assignee.

12. The method of claim 1 wherein the step of generating at least one warning comprises the step of generating at least one warning associated with a core technology of at least one patent assignee.

13. The method of claim 1 wherein the step of generating at least one suggested action comprises the step of generating at least one suggested action associated with a core technology of at least one patent assignee.

14. The method of claim 1 wherein the step of generating at least one warning comprises the step of generating at least one warning associated with a research and development effort of at least one patent assignee.

15. The method of claim 1 wherein the step of generating at least one suggested action comprises the step of generating at least one suggested action associated with a research and development effort of at least one patent assignee.

16. The method of claim 1 wherein the step of generating at least one suggested action comprises generating at least one suggested action based on a generated warning.

17. The method of claim 1 wherein reading patent-related data comprises the step of reading patent-related data that is associated with at least one technological area.

18. The method of claim 1 wherein reading patent-related data comprises the step of reading patent-related data that is associated with at least one patent assignee.

19. A method of analyzing patent-related data comprising:
reading patent-related data;
reading an analytic engine selection;
analyzing the read patent-related data in accordance with the analytic engine selection; and
generating and one or more messages in accordance with the analytic engine selection, wherein this step comprises generating one or more suggestion messages in accordance with the analytic engine selection.

20. A method of analyzing patent-related data comprising:
reading patent-related data from a data source;
reading an analytic engine selection;
identifying at least a first trend associated with the read patent-related data;
analyzing the at least first trend in accordance with the analytic engine selection; and
generating one or more messages in accordance with the analytic engine selection, wherein this step comprises generating one or more suggestion messages in accordance with the analytic engine selection.
